(19) United States
(12) Patent Application Publication
(10) Pub. No.: US 2010/0277796 A1
(43) Pub. Date: Nov. 4, 2010

(54) LIGHT COMBINER

(76) Inventors: Simon Magarill, Cincinnati, OH (US); David M. Snively, Cincinnati, OH (US)

Correspondence Address: 3M INNOVATIVE PROPERTIES COMPANY, PO BOX 33427, ST. PAUL, MN, 55133-3427, US

(21) Appl. No.: 12/810,207

(22) PCT Filed: Dec. 22, 2008
(86) PCT No.: PCT/US08/88037

§ 371 Date: Jun. 23, 2010

Related U.S. Application Data
(60) Provisional application No. 61/017,194, filed on Dec. 28, 2007.

(51) Int. Cl. G02B 27/28

(52) U.S. Cl. 359/487

(57) ABSTRACT

Light combiners and light splitters, and methods of using light combiners and light splitters are described. In particular, the description relates to light combiners and splitters that combine and split, respectively, light of different wavelength spectrums using polarizing beam splitters. The light combiners include arrangements of four polarizing beam splitters, such that three different wavelength spectrums of light can be directed into three of the polarizing beam splitters, and a combined light can be received from the fourth polarizing beam splitter. The light splitters can be the same configuration as the light combiners, but the direction of light travel is reversed to split, rather than combine, light. Polychromatic light can be directed into one of the polarizing beam splitters, and light having three different wavelength spectrums can be received from the other three polarizing beam splitters. The three different wavelength spectrums of light, the combined light, and the polychromatic light can be unpolarized light. The light combiners can be useful as unpolarized white light sources, such as in digital micro-mirror display projection systems.

### FIELD OF TECHNOLOGY

This description generally relates to light combiners and light splitters, and methods of using light combiners and light splitters. In particular, the description relates to light combiners and splitters that combine and split, respectively, light of different wavelength spectrums using polarizing beam splitters.

### BACKGROUND

Projection systems used for projecting an image on a screen can use multiple wavelength spectrum light sources, such as light emitting diodes (LEDs), with different wavelength spectrums to generate the illumination light. Several optical elements are disposed between the LEDs and the image display unit to combine and transfer the light from the LEDs to the image display unit. The image display unit can use various methods to impose an image on the light. For example, the image display unit may use polarization, as with transmissive or reflective liquid crystal displays (LCDs).

Still other projection systems used for projecting an image on a screen can use white light configured to imagewise reflect from a digital micro-mirror array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

### SUMMARY

Image brightness is an important parameter of a projection system. The brightness of color light sources and the efficiencies of collecting, combining, homogenizing and delivering the light to the image display unit all effect brightness. As the size of modern projector systems decreases, there is a need to maintain an adequate level of output brightness while at the same time keeping heat produced by the light sources at a low level that can be dissipated in a small projector system. There is a need for a light combining system that combines multiple color lights with increased efficiency to provide a light output with an adequate level of brightness without excessive power consumption by light sources.

Generally, the present description relates to light combiners comprising polarizing beam splitters, and methods of using light combiners. The present description also relates to light splitters comprising polarizing beams splitters, and methods of using light splitters.

In one aspect, a light combiner includes an arrangement of four polarizing beam splitters, each of which include two prisms each having two prism faces and two end faces, and a reflective polarizer disposed between the two prisms. The prism faces and ends can be polished so that total internal reflection can occur within each prism. Each of the faces and ends of each polarizing beam splitter can be in contact with an optically transmissive material having a refractive index lower than the refractive index of the prisms. The optically transmissive material can be air. The optically transmissive material can be an optical adhesive that bonds components of the light combiner together. The reflective polarizer can be a Cartesian reflective polarizer aligned to a first polarization direction, such as a polymeric multilayer optical film. The light combiner also includes four filters disposed between each pair of adjacent polarizing beam splitters. Each of the filters can change the polarization direction of at least one wavelength spectrum of light, while allowing other wavelength spectrums of light to remain unchanged. A reflector that changes the polarization direction and propagation direction of polarized light can be positioned adjacent one face of each of the four polarizing beam splitters. The polarization rotating reflector can be a quarter-wave retarder and a reflector, and the quarter-wave retarder can be aligned at 45° to the first polarization direction.

In another aspect, a method of combining light using the light combiner is described. A first, second and third wavelength spectrum of light is directed toward the first, second and third polarizing beam splitter respectively, and combined light is received from the fourth polarizing beam splitter. In one embodiment, each of the first, second and third wavelength spectrums of light are unpolarized, and the combined light is also unpolarized.

In yet another aspect, a method of splitting light using the light combiner is described. Polychromatic light is directed toward the fourth polarizing beam splitter, and a first, second and third wavelength spectrum of light is received from the first, second and third polarizing beam splitter, respectively. In one embodiment, the polychromatic light is unpolarized, and each of the first, second and third wavelength spectrums of light are also unpolarized.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter.

FIG. 2 is a perspective view of a polarizing beam splitter with a quarter-wave retarder.

FIG. 3 is a top schematic view showing a polarizing beam splitter with polished faces.

FIGS. 4A-4D are top schematic views of a light combiner.

FIGS. 5A-5D are top schematic views of a light combiner.

FIGS. 6A-6D are top schematic views of a light combiner.

FIGS. 7A-7D are top schematic views of a light combiner.

FIGS. 8A-8D are top schematic views of a light combiner.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The light combiners described herein receive different wavelength spectrum lights and produce a combined light output that includes the different wavelength spectrum lights. In some embodiments, the combined light has the same etendue as each of the received lights. The combined light can be a polychromatic combined light that comprises more than one wavelength spectrum of light. In one aspect, each of the different wavelength spectrums of light correspond to a different color light (e.g. red, green and blue), and the combined light output is white light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

When two or more unpolarized color lights are directed to the color combiner, each are split according to polarization by a reflective polarizer in a polarizing beam splitter (PBS). The light can be collimated, convergent, or divergent when it enters the PBS. Convergent or divergent light entering the PBS can be lost through one of the faces or ends of the PBS. To avoid such losses, all of the exterior faces of the PBS can be polished to enable total internal reflection (TIR) within the PBS. Enabling TIR improves the utilization of light entering the PBS, so that substantially all of the light entering the PBS within a range of angles is redirected to exit the PBS through the desired face.

At least one polarization component of each color light entering the light combiner passes through to a polarization rotating reflector. The polarization rotating reflector reverses the propagation direction of the light and alters the magnitude of the polarization components, depending of the type and orientation of a retarder disposed in the polarization rotating reflector. The polarization rotating reflector can include a mirror and a retarder. The retarder can provide any desired retardation, such as an eighth-wave retarder, a quarter-wave retarder, and the like. In embodiments described herein, there is an advantage to using a quarter-wave retarder and an associated reflector. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the color combiner result in efficient combined light output from the light combiner. In contrast, linearly polarized light is changed to a polarization state partway between s-polarization and p-polarization (either elliptical or linear) as it passes through other retarders and orientations, and can result in a lower efficiency of the combiner.

The components of a light combiner including prisms, reflective polarizers, quarter-wave retarders, mirrors and filters can be bonded together by a suitable optical adhesive. The optical adhesive used to bond the components together can have a lower index of refraction than the index of refraction of the prisms used in the light combiner. A light combiner that is fully bonded together offers advantages including alignment stability during assembly, handling and use.

The embodiments described above can be more readily understood by reference to the Figures and their accompanying description, which follows.

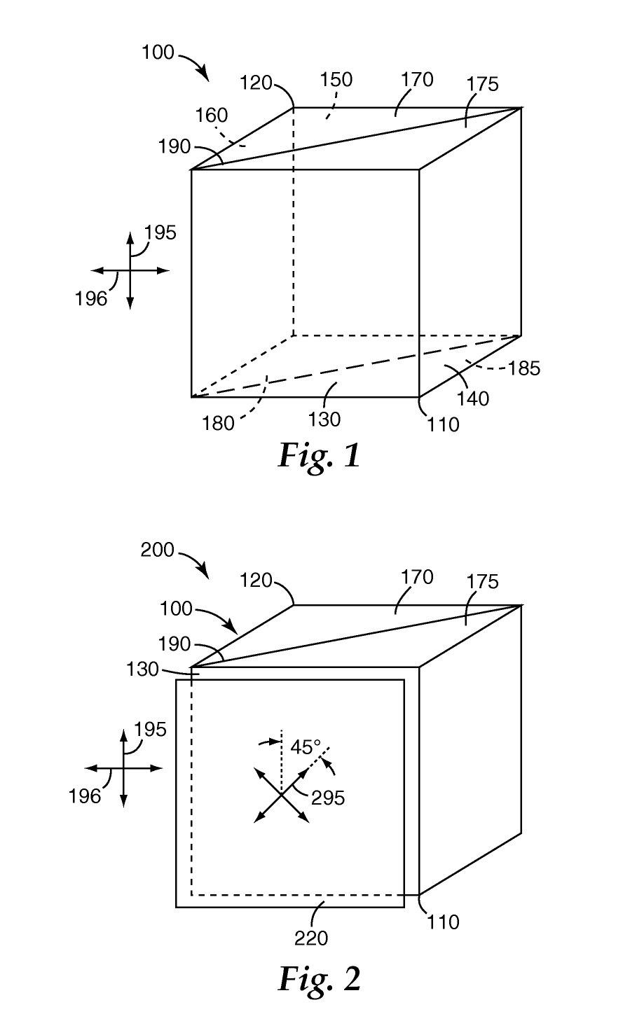

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves to clarify the description of PBS 100 in the discussion that follows. Reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis direction, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization direction 195, and perpendicular to a second polarization direction 196. In one embodiment, the first polarization direction 195 can be the s-polarization direction, and the second polarization direction 196 can be the p-polarization direction. As shown in FIG. 1, the first polarization direction 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

FIG. 2 is a perspective view of the alignment of a quarter-wave retarder to a PBS, as used in some embodiments. Quarter-wave retarders can be used to change the polarization state of incident light. PBS retarder system 200 includes PBS 100 having first and second prisms 110 and 120. A quarter-wave retarder 220 is disposed adjacent the first prism face 130. Reflective polarizer 190 is a Cartesian reflective polarizer film aligned to first polarization direction 195. Quarter-wave retarder 220 includes a quarter-wave polarization direction 295 that can be aligned at 45° to first polarization direction 195. Although FIG. 2 shows polarization direction 295 aligned at 45° to first polarization direction 195 in a clockwise direction, polarization direction 295 can instead be aligned at 45° to first polarization direction 195 in a counterclockwise direction. In some embodiments, quarter-wave polarization direction 295 can be aligned at any degree orientation to first polarization direction 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization direction. Other orientations of quarter-wave retarders can result in s-polarized light not being fully transformed to p-polarized light, and p-polarized light not being fully transformed to s-polarized light upon reflection from the mirrors, resulting in reduced efficiency of the light combiners described elsewhere in this description.

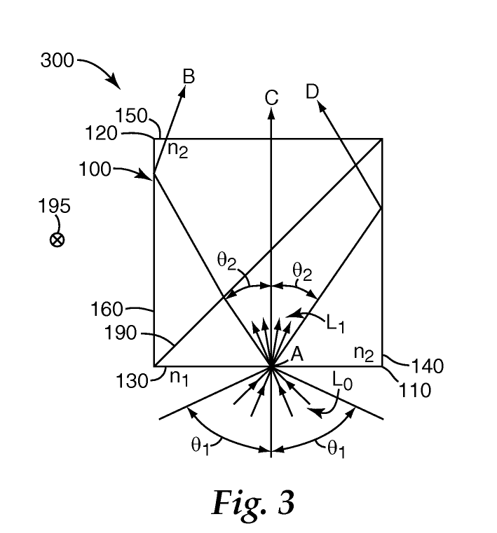

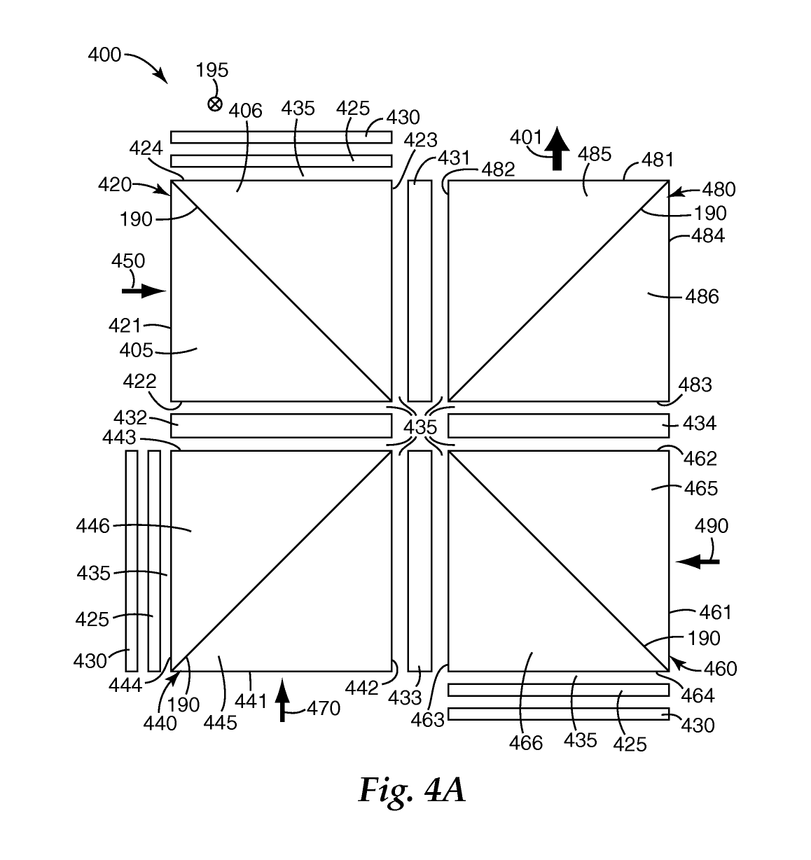

FIG. 3 shows a top view of a path of light rays within a polished PBS 300. According to one embodiment, the first, second, third and fourth prism faces 130, 140, 150, 160 of prisms 110 and 120 are polished external surfaces that are in contact with a material having an index of refraction “n₁” that is less than the index of refraction “n₂” of prisms 110 and 120. According to another embodiment, all of the external faces of the PBS 300 (including end faces, not shown) are polished faces that provide TIR of oblique light rays within PBS 300. The polished external surfaces are in contact with a material having an index of refraction “n₁” that is less than the index of refraction “n₂” of prisms 110 and 120. TIR improves light utilization in PBS 300, particularly when the light directed into PBS is not collimated along a central axis, i.e. the incoming light is either convergent or divergent. At least some light is trapped in PBS 300 by total internal reflections until it leaves through third prism face 150. In some cases, substantially all of the light is trapped in PBS 300 by total internal reflections until it leaves through third prism face 150.

As shown in FIG. 3, light rays L₀ enter first prism face 130 within a range of angles θ₁. Light rays L₁ within PBS 300 propagate within a range of angles θ₂ such that Snell's law is satisfied at prism faces 140, 160 and the end faces (not shown). Light rays “AB”, “AC” and “AD” represent three of the many paths of light through PBS 300, that intersect reflective polarizer 190 at different angles of incidence before exiting through third prism face 150. Light rays “AB” and “AD” also both undergo TIR at prism faces 140 and 160, respectively, before exiting. It is to be understood that ranges of angles θ₁ and θ₂ can be a cone of angles so that reflections can also occur at the end faces of PBS 300. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at high angles of incidence. Efficient splitting of polarized light using a MacNeille polarizer can be limited to incidence angles below about 6 or 7 degrees from the normal, since significant reflection of both polarization states occur at larger angles. Efficient splitting of polarized light using a wire-grid polarizer typically requires an air gap adjacent one side of the wires, and efficiency drops when a wire-grid polarizer is immersed in a higher index medium.

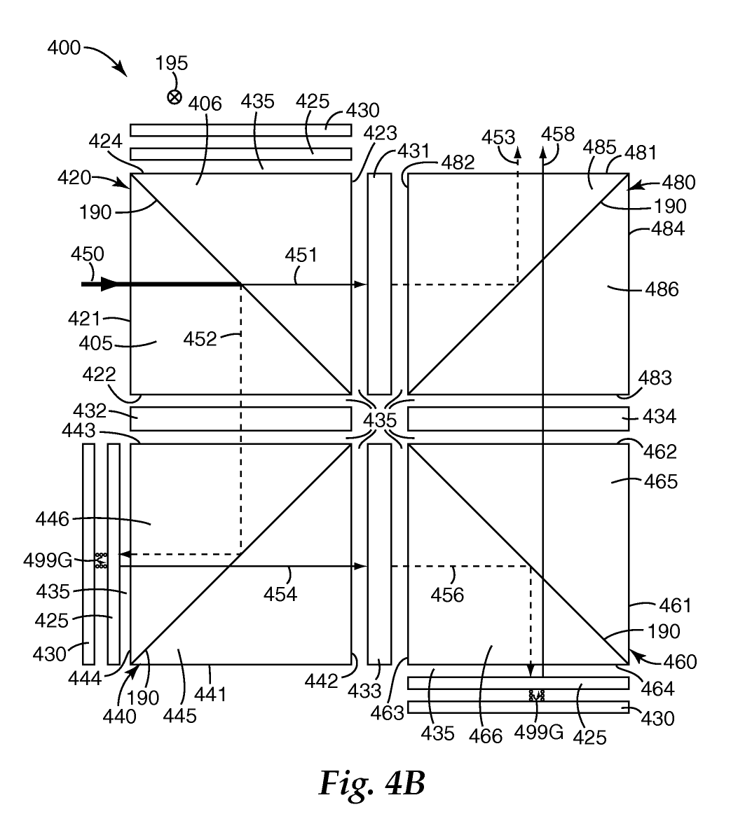

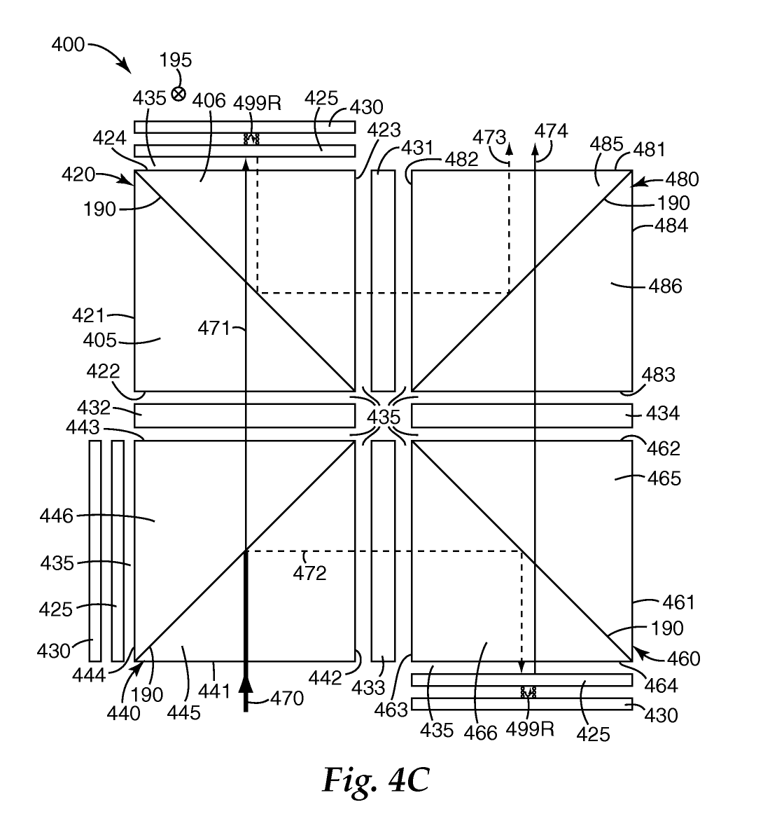

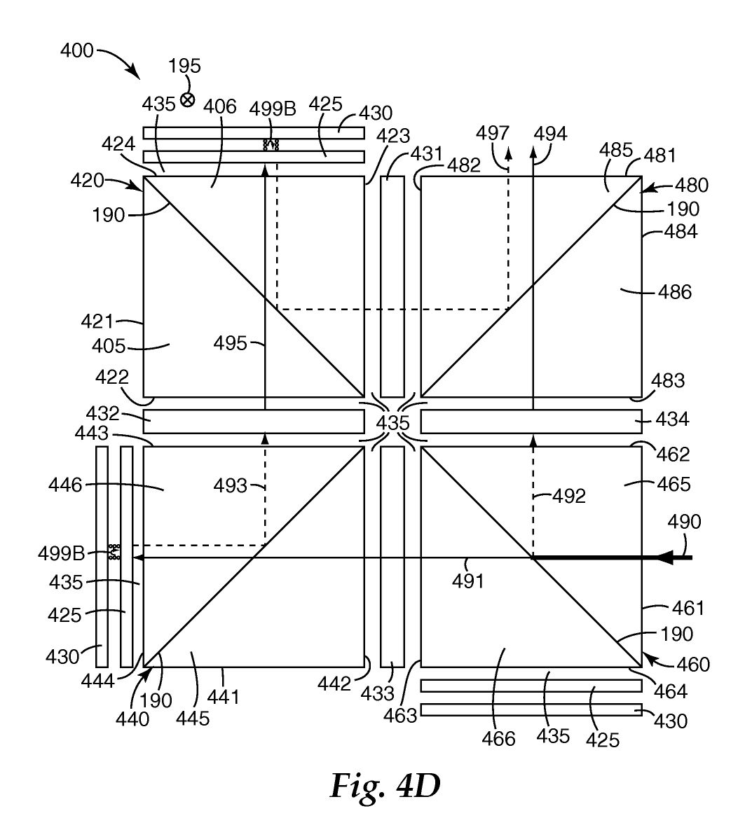

In one aspect, FIG. 4A is a top view schematic representation of a light combiner 400 that includes a first, second, third and fourth PBS 420, 440, 460, 480, respectively. A first, second, third and fourth filter, 431, 432, 433 and 434, respectively, is disposed between each pair of adjacent PBSs (420 and 480, 420 and 440, 440 and 460, 460 and 480), respectively. The first, second, third and fourth filters 431, 432, 433 and 434, can be color-selective stacked retardation polarization (CSSRP) filters. In the present description, reference is made to CSSRP filters throughout; however, any filter capable of effecting the wavelength selective rotation of polarization as described, can be used. Rotation of polarization in each of the CSSRP filters, 431, 432, 433 and 434, is dependent on the color of light passing through each of the filters. According to one aspect, each of the filters comprises a ColorSelect™ filter available from ColorLink Incorporated, Boulder, Colo. A polarization rotating reflector comprising retarder 425 and mirror 430 is disposed facing a fourth prism face 424, 444, 464 of each of the first, second and third PBS 420, 440, 460, respectively. In one embodiment, retarder 425 is a quarter-wave retarder orientated at 45° to a first polarization direction 195.

First PBS 420 includes a first prism 405 having a first and second prism face 421, 422 having a 90° angle between them, and a second prism 406 having a third and fourth prism face 423, 424 having a 90° angle between them. A reflective polarizer 190 is disposed between first and second prisms 405, 406 such that first prism face 421 is opposite third prism face 423. Reflective polarizer 190 can be a Cartesian reflective polarizer aligned to the first polarization direction 195 (in this view, perpendicular to the page). Reflective polarizer 190 can instead be a non-Cartesian polarizer.

Second PBS 440 includes a first prism 445 having a first and second prism face 441, 442 having a 90° angle between them, and a second prism 446 having a third and fourth prism face 443, 444 having a 90° angle between them. The reflective polarizer 190 is disposed between first and second prisms 445, 446 such that first prism face 441 is opposite third prism face 443.

Third PBS 460 includes a first prism 465 having a first and second prism face 461, 462 having a 90° angle between them, and a second prism 466 having a third and fourth prism face 463, 464 having a 90° angle between them. The reflective polarizer 190 is disposed between first and second prisms 465, 466 such that first prism face 461 is opposite third prism face 463.

Fourth PBS 480 includes a first prism 485 having a first and second prism face 481, 482 having a 90° angle between them, and a second prism 486 having a third and fourth prism face 483, 484 having a 90° angle between them. The reflective polarizer 190 is disposed between first and second prisms 485, 486 such that first prism face 481 is opposite third prism face 483.

An optically transmissive material 435 is disposed adjacent each of the prism faces. The optically transmissive material 435 can be any material that has an index of refraction lower than the index of refraction of prisms 405, 406, 445, 446, 465, 466, 485, 486. In one embodiment, the optically transmissive material 435 is air. In another embodiment, the optically transmissive material 435 is an optical adhesive which bonds the retarders 425 and the CSSRP filters 431, 432, 433, 434, to their respective prism faces.

In one aspect, a method of combining light using the light combiner 400 is shown in FIG. 4A. A first wavelength spectrum light 450 is directed toward first prism face 421 of first PBS 420, a second wavelength spectrum light 470 is directed toward first prism face 441 of second PBS 440, a third wavelength spectrum light 490 is directed toward first prism face 461 of third PBS 460, and a combined light 401 is received from first prism face 481 of fourth PBS 480. In one embodiment, at least two of the first, second or third wavelength spectrum light 450, 470, 490 is directed toward the respective prism faces 421, 441, 461, and combined light 401 is received from first prism face 461 of fourth PBS 480.

In one embodiment, first, second and third wavelength spectrum light 450, 470, 490 are unpolarized light, and the combined light 401 is also unpolarized. Each of the first, second, and third lights 450, 470, 490 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

In one embodiment, first and third CSSRP filters 431, 433 are selected to change the polarization direction of the first wavelength spectrum light 450, and the second and fourth CSSRP filters 432, 434 are selected to change the polarization direction of the third wavelength spectrum light 490. In a further embodiment shown in FIGS. 4A-4D, the first, a second and the third wavelength spectrum light 450, 470, 490 are green, red and blue unpolarized light, respectively, the first and third CSSRP filters 431, 433 are green CSSRP filters, the second and fourth CSSRP filters 432, 434 are blue CSSRP filters, and the combined light 401 is white unpolarized light.

Turning now to FIG. 4B, the optical path of unpolarized green light 450 through light combiner 400 is described. In this embodiment, unpolarized green light 450 enters first PBS 420 through first prism face 421 and exits fourth PBS 480 through first prism face 481 as unpolarized green light comprising green light 458 having the first polarization direction, and green light 453 having the second polarization direction.

Green light 450 enters first PBS 420 through first prism face 421, intercepts reflective polarizer 190, and is split into green light 451 having the first polarization direction and green light 452 having the second polarization direction.

Green light 451 having the first polarization direction exits first PBS 420 through third prism face 423, changes polarization direction as it passes through first CSSRP filter 431, and enters fourth PBS 480 through second prism face 482 as green light 453 having the second polarization direction. Green light 453 having the second polarization direction reflects from reflective polarizer 190, and exits fourth PBS 480 through first prism face 481 as green light 453 having the second polarization direction.

Green light 452 having the second polarization direction exits first PBS 420 through second prism face 422, passes through second CSSRP filter 432 without change of polarization, enters second PBS 440 through third prism face 443, reflects from reflective polarizer 190, exits second PBS 440 through fourth prism face 444, and changes to green circularly polarized light 499G as it passes through quarter-wave retarder 425. Green circularly polarized light 499G reflects from mirror 430, changes direction of circular polarization, and changes to green light 454 having the first polarization direction as it passes through quarter-wave retarder 425. Green light 454 having the first polarization direction enters second PBS 440 through fourth prism face 444, passes through reflective polarizer 190, exits second PBS 440 through second prism face 442, and changes polarization direction as it passes through third CSSRP filter 433, to become green light 456 having the second polarization direction. Green light 456 having the second polarization direction enters third PBS 460 through third prism face 463, reflects from reflective polarizer 190, exits third PBS 460 through fourth prism face 464, changes to green circularly polarized light 499G as it passes through quarter-wave retarder 425, changes direction of circular polarization as it reflects from mirror 430, and becomes green light 458 having the first polarization direction as it again passes through quarter-wave retarder 425. Green light 458 having the first polarization direction enters third PBS 460 through fourth prism face 464, passes through reflective polarizer 190, exits third PBS 460 through second prism face 462, passes through fourth second CSSRP filter 434 without change of polarization, enters fourth PBS 480 through fourth prism face 484, passes through reflective polarizer 190, and exits fourth PBS through first prism face 481 as green light 458 having the first polarization direction.

FIG. 4C shows the optical path of unpolarized red light 470 through light combiner 400. In this embodiment, unpolarized red light 470 enters second PBS 440 through first prism face 441 and exits fourth PBS 480 through first prism face 481 as unpolarized red light comprising red light 474 having the first polarization direction, and red light 473 having the second polarization direction.

Red light 470 enters second PBS 440 through first prism face 441, intercepts reflective polarizer 190, and is split into red light 471 having the first polarization direction and red light 472 having the second polarization direction.

Red light 471 having the first polarization direction exits second PBS 440 through third prism face 443, passes unchanged through second CSSRP filter 432, enters first PBS 420 through second prism face 422, passes through reflective polarizer 190, exits first PBS 420 through fourth prism face 424, and changes to red circularly polarized light 499R as it passes through quarter-wave retarder 425. Red circularly polarized light 499R changes the direction of circular polarization as it reflects from mirror 430, changes to red light 473 having the second polarization direction as it passes through quarter-wave retarder 425, and re-enters first PBS 420 through fourth prism face 424. Red light 473 having the second polarization direction reflects from reflective polarizer 190, exits first PBS 420 through third prism face 423, passes unchanged through first CSSRP filter 431, enters fourth PBS 480 through second prism face 482, reflects from reflective polarizer 190, and exits fourth PBS 480 through first prism face 481 as red light 473 having the second polarization direction.

Red light 472 having the second polarization direction exits second PBS 440 through second prism face 442, passes through third CSSRP filter 433 without change of polarization, enters third PBS 460 through third prism face 463, reflects from reflective polarizer 190, exits third PBS 460 through fourth prism face 464, and changes to red circularly polarized light 499R as it passes through quarter-wave retarder 425. Red circularly polarized light 499R reflects from mirror 430, changes direction of circular polarization, and changes to red light 474 having the first polarization direction as it passes through quarter-wave retarder 425. Red light 474 having the first polarization direction enters third PBS 460 through fourth prism face 464, passes through reflective polarizer 190, exits third PBS 460 through second prism face 462, passes unchanged through fourth CSSRP filter 434, enters fourth PBS 480 through third prism face 483, passes through reflective polarizer 190, and exits fourth PBS 480 through first prism face 481 as red light 474 having the first polarization direction.

FIG. 4D shows the optical path of unpolarized blue light 490 through light combiner 400. In this embodiment, unpolarized blue light 490 enters third PBS 460 through first prism face 461 and exits fourth PBS 480 through first prism face 481 as unpolarized blue light comprising blue light 494 having the first polarization direction, and blue light 497 having the second polarization direction.

Blue light 490 enters third PBS 460 through first prism face 441, intercepts reflective polarizer 190, and is split into blue light 491 having the first polarization direction and blue light 492 having the second polarization direction.

Blue light 491 having the first polarization direction exits third PBS 460 through third prism face 463, passes unchanged through third CSSRP filter 433, enters second PBS 440 through second prism face 442, passes through reflective polarizer 190, exits second PBS 440 through fourth prism face 444, and changes to blue circularly polarized light 499B as it passes through quarter-wave retarder 425. Blue circularly polarized light 499B changes the direction of circular polarization as it reflects from mirror 430, changes to blue light 493 having the second polarization direction as it passes through quarter-wave retarder 425, and re-enters second PBS 440 through fourth prism face 444. Blue light 493 having the second polarization direction reflects from reflective polarizer 190, exits second PBS 440 through third prism face 443, and changes polarization direction as it passes through second CSSRP filter 432, to become blue light 495 having the first polarization direction. Blue light 495 having the first polarization direction enters first PBS 420 through second prism face 422, passes through reflective polarizer 190, exits first PBS 420 through fourth prism face 481, and changes to blue circularly polarized light 499B as it passes through quarter-wave retarder 425. Blue circularly polarized light 499B changes direction of circular polarization as it reflects from mirror 430, changes to blue light 497 having the second direction of polarization as it passes through quarter-wave retarder 425, enters first PBS 420 through fourth prism face 424, reflects from reflective polarizer 190, and exits first PBS 420 through third prism face 423. Blue light 497 having the second polarization direction passes through first CSSRP filter 431 without change of polarization, enters fourth PBS 480 through second prism face 482, reflects from reflective polarizer 190, and exits fourth PBS 480 through first prism face 481 as blue light 497 having the second polarization direction.

Blue light 492 having the second polarization direction exits third PBS 490 through second prism face 462, changes polarization as it passes through fourth CSSRP filter 434 to become blue light 494 having the first polarization direction. Blue light 494 having the first polarization direction enters fourth PBS 480 through third prism face 483, passes through reflective polarizer 190, and exits fourth PBS 480 through first prism face 481 as blue light 494 having the first polarization direction.

In a further aspect, a method of splitting light using the light combiner 400 includes changing the propagation direction of the first, second, third, and combined light, 450, 470, 490, 401, respectively, shown in FIG. 4A-4D. Combined light 401 is directed toward first prism face 481 of fourth PBS 480, and at least one of the first, second and third wavelength spectrum light is received from first prism face 421, 441, 461 of first, second and third PBS 420, 440, 460, respectively.

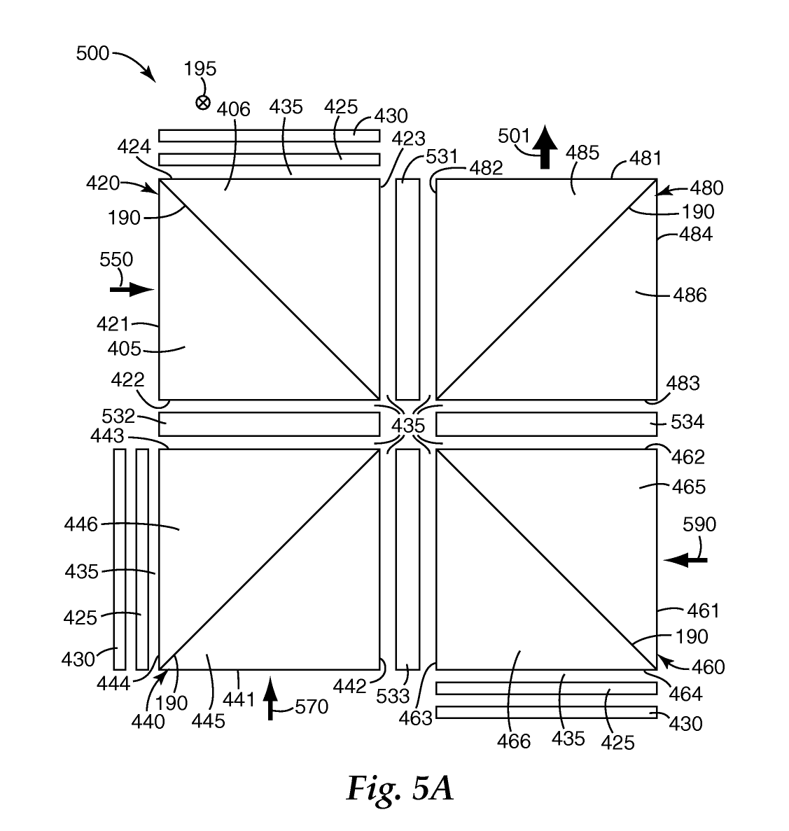

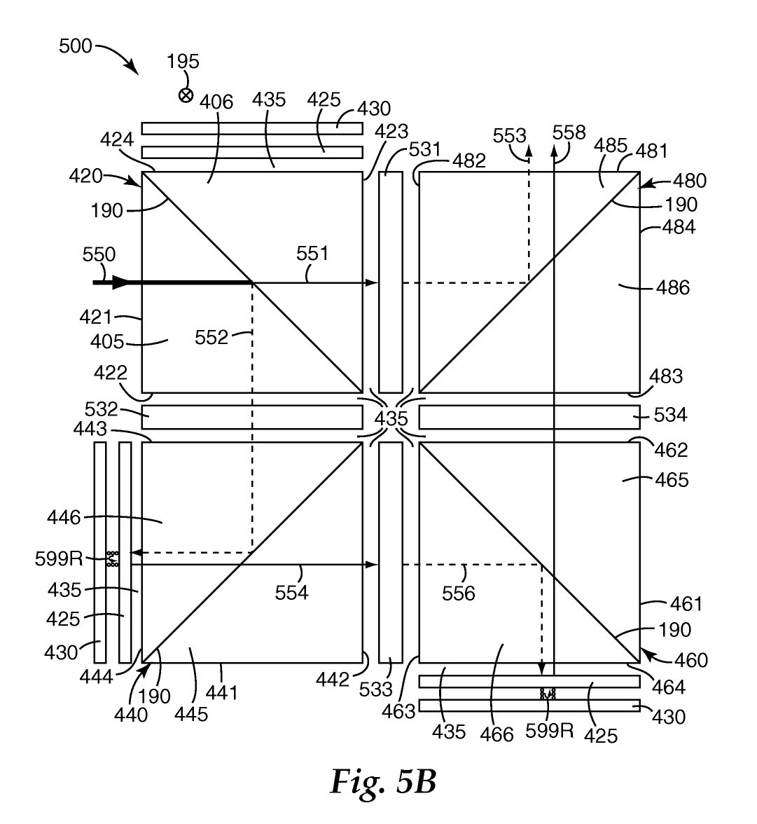

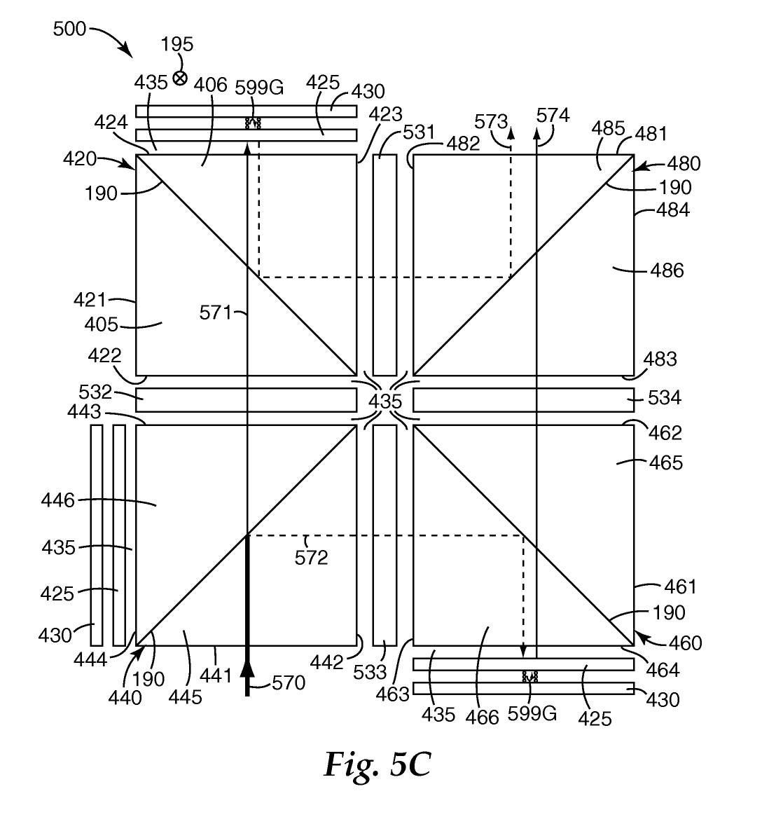

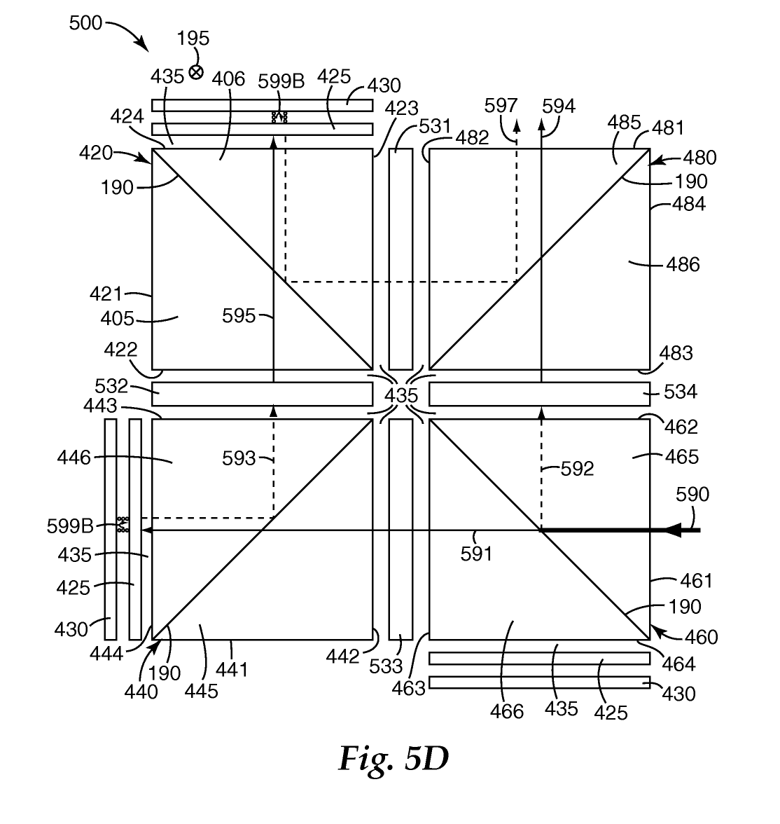

FIG. 5A describes one embodiment of a light combiner 500, where the first, second, third and fourth CSSRP filters, 431, 432, 433 and 434 of light combiner 400 are replaced by a first, second, third and fourth CSSRP filters, 531, 532, 533 and 534, respectively.

In one aspect, a method of combining light using the light combiner 500 is shown in FIG. 5A. A first wavelength spectrum light 550 is directed toward first prism face 421 of first PBS 420, a second wavelength spectrum light 570 is directed toward first prism face 441 of second PBS 440, a third wavelength spectrum light 590 is directed toward first prism face 461 of third PBS 460, and a combined light 501 is received from first prism face 481 of fourth PBS 480. In one embodiment, at least two of the first, second or third wavelength spectrum light 550, 570, 590 are directed toward the respective prism faces 421, 441, 461, and combined light 501 is received from first prism face 461 of fourth PBS 480. In one embodiment, first, second and third wavelength spectrum light 550, 570, 590 are unpolarized light, and the combined light 501 is also unpolarized. Each of the first, second, and third lights 550, 570, 590 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

In one embodiment, first and third CSSRP filters 531, 533 are selected to change the polarization direction of the first wavelength spectrum light 550, and the second and fourth CSSRP filters 532, 534 are selected to change the polarization direction of the third wavelength spectrum light 590. In a further embodiment shown in FIGS. 5A-5D, the first, a second and the third wavelength spectrum light 550, 570, 590 are red, green and blue respectively, the first and third CSSRP filters 531, 533 are red/cyan CSSRP filters, and the second and fourth CSSRP filters 532,534 are blue/yellow CSSRP filters.

Turning now to FIG. 5B, the optical path of unpolarized red light 550 through light combiner 500 is described. In this embodiment, unpolarized red light 550 enters first PBS 420 through first prism face 421 and exits fourth PBS 480 through first prism face 481 as unpolarized red light comprising red light 558 having the first polarization direction, and red light 553 having the second polarization direction.

Red light 550 enters first PBS 420 through first prism face 421, intercepts reflective polarizer 190, and is split into red light 551 having the first polarization direction and red light 552 having the second polarization direction.

Red light 551 having the first polarization direction exits first PBS 420 through third prism face 423, changes polarization direction as it passes through first CSSRP filter 531, and enters fourth PBS 480 through second prism face 482 as red light 553 having the second polarization direction. Red light 553 having the second polarization direction reflects from reflective polarizer 190, and exits fourth PBS 480 through first prism face 481 as red light 553 having the second polarization direction.

Red light 552 having the second polarization direction exits first PBS 420 through second prism face 422, passes through second CSSRP filter 532 without change of polarization, enters second PBS 440 through third prism face 443, reflects from reflective polarizer 190, exits second PBS 440 through fourth prism face 444, and changes to red circularly polarized light 599R as it passes through quarter-wave retarder 425. Red circularly polarized light 599R reflects from mirror 430, changes direction of circular polarization, and changes to red light 554 having the first polarization direction as it passes through quarter-wave retarder 425. Red light 554 having the first polarization direction enters second PBS 440 through fourth prism face 444, passes through reflective polarizer 190, exits second PBS 440 through second prism face 442, and changes polarization direction as it passes through third CSSRP filter 533, to become red light 556 having the second polarization direction. Red light 556 having the second polarization direction enters third PBS 460 through third prism face 463, reflects from reflective polarizer 190, exits third PBS 460 through fourth prism face 464, changes to red circularly polarized light 599R as it passes through quarter-wave retarder 425, changes direction of circular polarization as it reflects from mirror 430, and becomes red light 558 having the first polarization direction as it again passes through quarter-wave retarder 425. Red light 558 having the first polarization direction enters third PBS 460 through fourth prism face 464, passes through reflective polarizer 190, exits third PBS 460 through second prism face 462, passes through fourth second CSSRP filter 534 without change of polarization, enters fourth PBS 480 through fourth prism face 484, passes through reflective polarizer 190, and exits fourth PBS through first prism face 481 as red light 558 having the first polarization direction.

FIG. 5C shows the optical path of unpolarized green light 570 through light combiner 500. In this embodiment, unpolarized green light 570 enters second PBS 440 through first prism face 441 and exits fourth PBS 480 through first prism face 481 as unpolarized green light comprising green light 574 having the first polarization direction, and green light 573 having the second polarization direction.

Green light 570 enters second PBS 440 through first prism face 441, intercepts reflective polarizer 190, and is split into green light 571 having the first polarization direction and green light 572 having the second polarization direction.

Green light 571 having the first polarization direction exits second PBS 440 through third prism face 443, passes unchanged through second CSSRP filter 532, enters first PBS 420 through second prism face 422, passes through reflective polarizer 190, exits first PBS 420 through fourth prism face 424, and changes to green circularly polarized light 599G as it passes through quarter-wave retarder 425. Green circularly polarized light 599G changes the direction of circular polarization as it reflects from mirror 430, changes to green light 573 having the second polarization direction as it passes through quarter-wave retarder 425, and re-enters first PBS 420 through fourth prism face 424. Green light 573 having the second polarization direction reflects from reflective polarizer 190, exits first PBS 420 through third prism face 423, passes unchanged through first CSSRP filter 531, enters fourth PBS 480 through second prism face 482, reflects from reflective polarizer 190, and exits fourth PBS 480 through first prism face 481 as green light 573 having the second polarization direction.

Green light 572 having the second polarization direction exits second PBS 440 through second prism face 442, passes through third CSSRP filter 533 without change of polarization, enters third PBS 460 through third prism face 463, reflects from reflective polarizer 190, exits third PBS 460 through fourth prism face 464, and changes to green circularly polarized light 599G as it passes through quarter-wave retarder 425. Green circularly polarized light 599G reflects from mirror 430, changes direction of circular polarization, and changes to green light 574 having the first polarization direction as it passes through quarter-wave retarder 425. Green light 574 having the first polarization direction enters third PBS 460 through fourth prism face 464, passes through reflective polarizer 190, exits third PBS 460 through second prism face 462, passes unchanged through fourth CSSRP filter 534, enters fourth PBS 480 through third prism face 483, passes through reflective polarizer 190, and exits fourth PBS 480 through first prism face 481 as green light 574 having the first polarization direction.

FIG. 5D shows the optical path of unpolarized blue light 590 through light combiner 500. In this embodiment, unpolarized blue light 590 enters third PBS 460 through first prism face 461 and exits fourth PBS 480 through first prism face 481 as unpolarized blue light comprising blue light 594 having the first polarization direction, and blue light 597 having the second polarization direction.

Blue light 590 enters third PBS 460 through first prism face 441, intercepts reflective polarizer 190, and is split into blue light 591 having the first polarization direction and blue light 592 having the second polarization direction.

Blue light 591 having the first polarization direction exits third PBS 460 through third prism face 463, passes unchanged through third CSSRP filter 533, enters second PBS 440 through second prism face 442, passes through reflective polarizer 190, exits second PBS 440 through fourth prism face 444, and changes to blue circularly polarized light 599B as it passes through quarter-wave retarder 425. Blue circularly polarized light 599B changes the direction of circular polarization as it reflects from mirror 430, changes to blue light 593 having the second polarization direction as it passes through quarter-wave retarder 425, and re-enters second PBS 440 through fourth prism face 444. Blue light 593 having the second polarization direction reflects from reflective polarizer 190, exits second PBS 440 through third prism face 443, and changes polarization direction as it passes through second CSSRP filter 532, to become blue light 595 having the first polarization direction. Blue light 595 having the first polarization direction enters first PBS 420 through second prism face 422, passes through reflective polarizer 190, exits first PBS 420 through fourth prism face 481, and changes to blue circularly polarized light 599B as it passes through quarter-wave retarder 425. Blue circularly polarized light 599B changes direction of circular polarization as it reflects from mirror 430, changes to blue light 597 having the second direction of polarization as it passes through quarter-wave retarder 425, enters first PBS 420 through fourth prism face 424, reflects from reflective polarizer 190, and exits first PBS 420 through third prism face 423. Blue light 597 having the second polarization direction passes through first CSSRP filter 531 without change of polarization, enters fourth PBS 480 through second prism face 482, reflects from reflective polarizer 190, and exits fourth PBS 480 through first prism face 481 as blue light 597 having the second polarization direction.

Blue light 592 having the second polarization direction exits third PBS 490 through second prism face 462, changes polarization as it passes through fourth CSSRP filter 534 to become blue light 594 having the first polarization direction. Blue light 594 having the first polarization direction enters fourth PBS 480 through third prism face 483, passes through reflective polarizer 190, and exits fourth PBS 480 through first prism face 481 as blue light 594 having the first polarization direction.

In a further aspect, a method of splitting light using the light combiner 500 includes changing the propagation direction of the first, second, third, and combined light, 550, 570, 590, 501, respectively, shown in FIG. 5A-5D. Combined light 501 is directed toward first prism face 481 of fourth PBS 580, and at least one of the first, second and third wavelength spectrum light is received from first prism face 421, 441, 461 of first, second and third PBS 520, 540, 560, respectively.

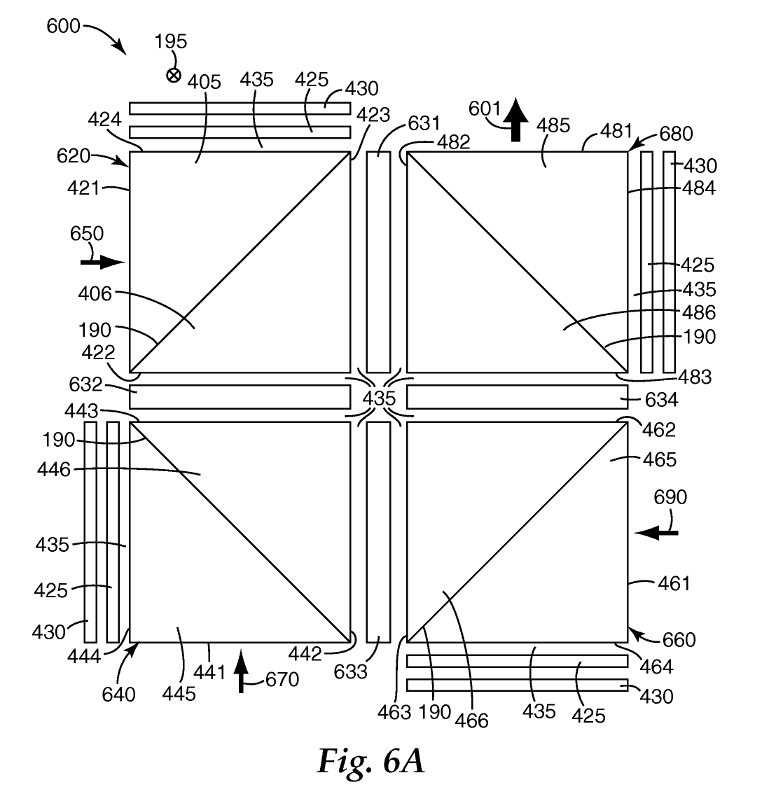

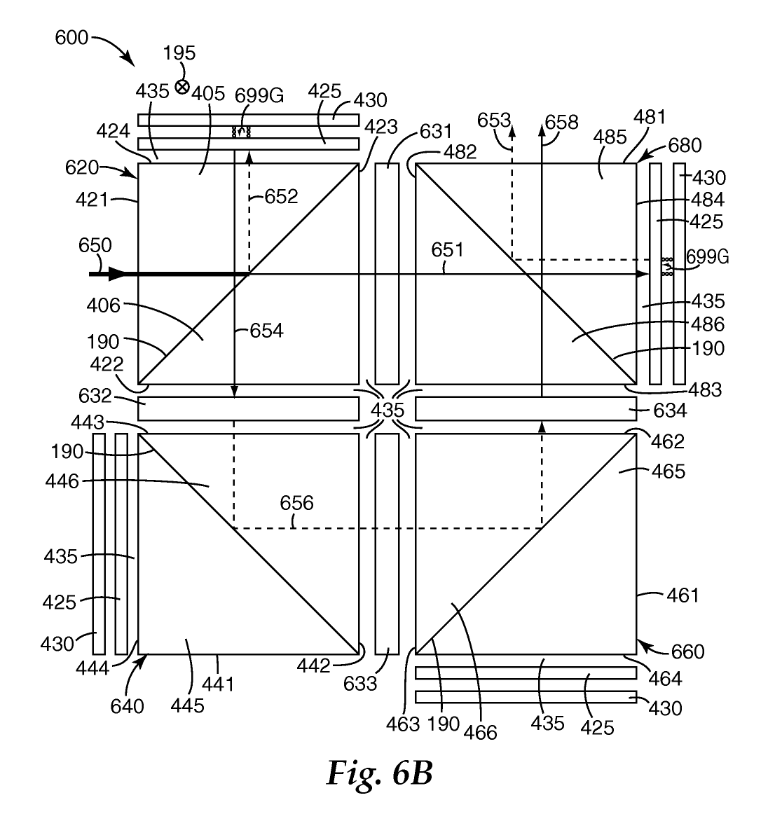

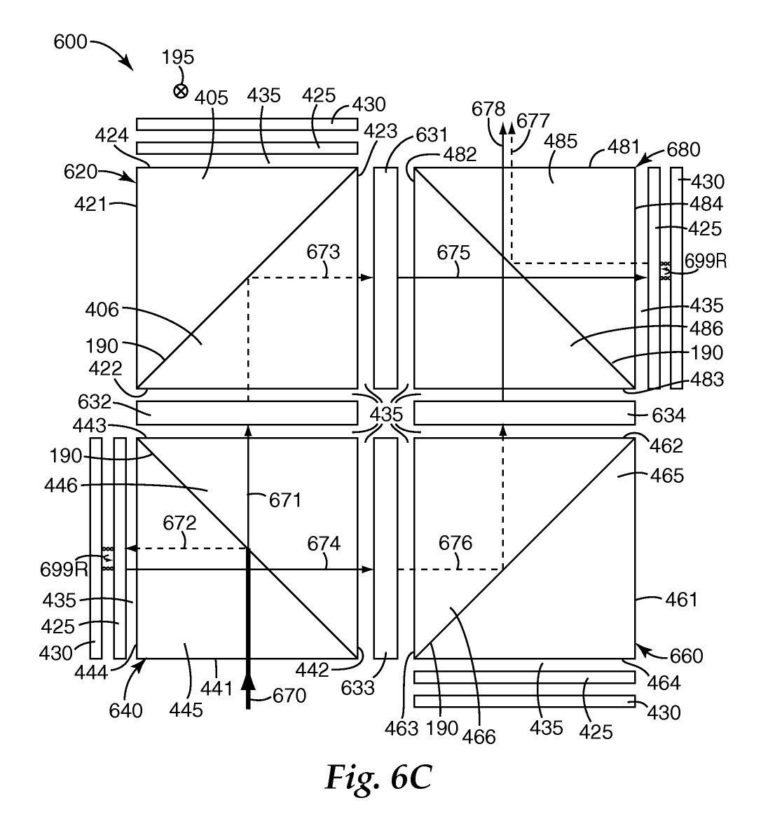

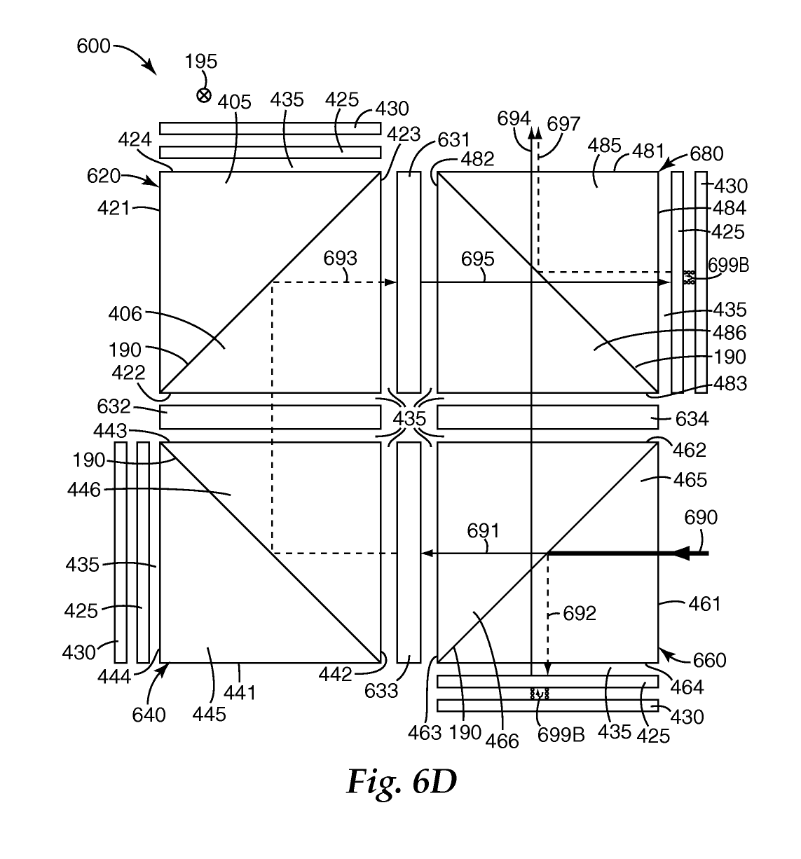

In one aspect, FIG. 6A is a top view schematic representation of a light combiner 600 that includes a first, second, third and fourth PBS 620, 640, 660, 680, respectively. A first, second, third and fourth CSSRP filter, 631, 632, 633, and 634, respectively, is disposed between each pair of adjacent PBSs (620 and 680, 620 and 640, 640 and 660, 660 and 680), respectively. Rotation of polarization in each of the CSSRP filters, 631, 632, 633, and 634, is dependent on the color of light passing through each of the individual filters. Each individual CSSRP filter is adapted to allow light of at least one color to pass through the filter unchanged, while altering the polarization direction of at least one other color. According to one aspect, each of the filters comprise a ColorSelect™ filter available from ColorLink Incorporated, Boulder, Colo. A polarization rotating reflector comprising retarder 425 and mirror 430 is disposed facing a fourth prism face 424, 444, 464, 484 of each of the first, second, third and fourth PBS 620, 640, 660, 680, respectively. In one embodiment, retarder 425 is a quarter-wave retarder orientated at 45° to a first polarization direction 195.

First PBS 620 includes a first prism 405 having a first and fourth prism face 421, 424 having a 90° angle between them, and a second prism 406 having a second and third prism face 422, 423 having a 90° angle between them. A reflective polarizer 190 is disposed between first and second prisms 405, 406 such that first prism face 421 is opposite third prism face 423. Reflective polarizer 190 can be a Cartesian reflective polarizer aligned to the first polarization direction 195 (in this view, perpendicular to the page). Reflective polarizer 190 can instead be a non-Cartesian polarizer.

Second PBS 640 includes a first prism 445 having a first and fourth prism face 441, 444 having a 90° angle between them, and a second prism 446 having a second and third prism face 442, 443 having a 90° angle between them. The reflective polarizer 190 is disposed between first and second prisms 445, 446 such that first prism face 441 is opposite third prism face 443.

Third PBS 660 includes a first prism 465 having a first and fourth prism face 461, 464 having a 90° angle between them, and a second prism 466 having a second and third prism face 462, 463 having a 90° angle between them. The reflective polarizer 190 is disposed between first and second prisms 465, 466 such that first prism face 461 is opposite third prism face 463.

Fourth PBS 680 includes a first prism 485 having a first and fourth prism face 481, 484 having a 90° angle between them, and a second prism 486 having a second and third prism face 482, 483 having a 90° angle between them. The reflective polarizer 190 is disposed between first and second prisms 485, 486 such that first prism face 481 is opposite third prism face 483.

An optically transmissive material 435 is disposed adjacent each of the prism faces. The optically transmissive material 435 can be any material that has an index of refraction lower than the index of refraction of prisms 405, 406, 445, 446, 465, 466, 485, 486. In one embodiment, the optically transmissive material 435 is air. In another embodiment, the optically transmissive material 435 is an optical adhesive which bonds the retarders 425 and the CSSRP filters 631, 632, 633, 634, to their respective prism faces.

In one aspect, a method of combining light using the light combiner 600 is shown in FIG. 6A. A first wavelength spectrum light 650 is directed toward first prism face 421 of first PBS 620, a second wavelength spectrum light 670 is directed toward first prism face 441 of second PBS 640, a third wavelength spectrum light 690 is directed toward first prism face 461 of third PBS 660, and a combined light 601 is received from first prism face 481 of fourth PBS 680. In one embodiment, at least two of the first, second or third wavelength spectrum light 650, 670, 690 is directed toward the respective prism faces 421, 441, 461, and combined light 601 is received from first prism face 461 of fourth PBS 680.

In one embodiment, first, second and third wavelength spectrum light 650, 670, 690 are unpolarized light, and the combined light 601 is also unpolarized. Each of the first, second, and third lights 650, 670, 690 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

In one embodiment, first and third CSSRP filters 631, 633 are selected to change the polarization direction of the second and third wavelength spectrum light 670, 690, and the second and fourth CSSRP filters 632, 634 are selected to change the polarization direction of the first and second wavelength spectrum light 650, 670. In a further embodiment shown in FIGS. 6A-6D, the first, second and third wavelength spectrum light 650, 670, 690 are green, red and blue unpolarized light, respectively, the first and third CSSRP filters 631, 633 are green/magenta CSSRP filters that rotate the polarization direction of red and blue light while preserving the polarization direction of green light; the second and fourth CSSRP filters 632, 634 are yellow/blue CSSRP filters that rotate the polarization direction of red and green light while preserving the polarization direction of blue light; and the combined light 601 is white unpolarized light.

Turning now to FIG. 6B, the optical path of unpolarized green light 650 through light combiner 600 is described. In this embodiment, unpolarized green light 650 enters first PBS 620 through first prism face 421 and exits fourth PBS 680 through first prism face 481 as unpolarized green light comprising green light 658 having the first polarization direction, and green light 653 having the second polarization direction.

Green light 650 enters first PBS 620 through first prism face 421, intercepts reflective polarizer 190, and is split into green light 651 having the first polarization direction and green light 652 having the second polarization direction.

Green light 651 having the first polarization direction exits first PBS 620 through third prism face 423, passes unchanged through first CSSRP filter 631, enters fourth PBS 680 through second prism face 482, passes through reflective polarizer 190, exits fourth PBS 680 through fourth prism face 484, and changes to green circularly polarized light 699G as it passes through quarter-wave retarder 425. Green circularly polarized light 699G changes direction of circular polarization as it reflects from mirror 430, changes to green light 653 having the second polarization direction as it passes through quarter-wave retarder 425, enters fourth PBS 680 through fourth prism face 484, reflects from reflective polarizer 190, and exits fourth PBS 680 through first prism face 481 as green light 653 having the second polarization direction.

Green light 652 having the second polarization direction exits first PBS 620 through fourth prism face 424, and changes to green circularly polarized light 699G as it passes through quarter-wave retarder 425. Green circularly polarized light 699G changes direction of circular polarization as it reflects from mirror 430, changes to green light 654 having the first polarization direction as it passes through quarter-wave retarder 425, re-enters first PBS 620 through fourth prism face 424, passes through reflective polarizer 190 and exits first PBS through second prism face 422. Green light 654 having the first polarization direction changes to green light 656 having the second polarization direction as it passes through second CSSRP filter 632, enters second PBS 640 through third prism face 443, reflects from reflective polarizer 190, exits second PBS 640 through second prism face 442, passes through third CSSRP filter 633 without change of polarization, and enters third PBS 660 through third prism face 463. Green light 656 having the second polarization direction reflects from reflective polarizer 190, exits third PBS 660 through second prism face 462, changes to green light 658 having the first polarization direction as it passes through fourth CSSRP filter 634, enters fourth PBS 680 through third prism face 483, passes through reflective polarizer 190 and exits fourth PBS 680 through first prism face 481 as green light 658 having the first polarization direction.

FIG. 6C shows the optical path of unpolarized red light 670 through light combiner 600. In this embodiment, unpolarized red light 670 enters second PBS 640 through first prism face 441 and exits fourth PBS 680 through first prism face 481 as unpolarized red light comprising red light 678 having the first polarization direction, and red light 677 having the second polarization direction.

Red light 670 enters second PBS 640 through first prism face 441 and intercepts reflective polarizer 190 where it is split into red light 671 having the first polarization direction and red light 672 having the second polarization direction.

Red light 671 having the first polarization direction, exits second PBS 640 through third prism face 443 and changes to red light 673 having the second polarization direction as it passes through second CSSRP filter 632. Red light 673 having the second polarization direction enters first PBS 620 through second prism face 422, reflects from reflective polarizer 190, exits first PBS 620 through third prism face 423, and changes to red light 675 having the first polarization direction as it passes through first CSSRP filter 631. Red light 675 having the first polarization direction enters fourth PBS 680 through second prism face 482, passes through reflective polarizer 190, exits fourth PBS 680 through fourth prism face 484 and changes to red circularly polarized light 699R as it passes through quarter-wave retarder 425. Red circularly polarized light 699R changes direction of circular polarization as it reflects from mirror 430, changes to red light 677 having the second polarization direction as it passes through quarter-wave retarder 425, enters fourth PBS 680 through fourth prism face 484, reflects from reflective polarizer 190, and exits fourth PBS 680 through first prism face 481 as red light 677 having the second polarization direction.

Red light 672 having the second polarization direction reflects from reflective polarizer 190, exits second PBS 640 through fourth prism face 444, changes to red circularly polarized light 699R as it passes through quarter-wave retarder 425, changes direction of circular polarization as it reflects from mirror 430, and changes to red light 674 having the first polarization direction as it again passes through quarter-wave retarder 425. Red light 674 having the first polarization direction enters second PBS 640 through fourth prism face 444, passes through reflective polarizer 190, exits second PBS 640 through second prism face 442, and changes to red light 676 having the second polarization direction as it passes through third CSSRP filter 633. Red light 676 having the second polarization direction enters third PBS 660 through third prism face 463, reflects from reflective polarizer 190, exits third PBS 660 through second prism face 462, and changes to red light 678 having the first polarization direction as it passes through fourth CSSRP filter 634. Red light 678 having the first polarization direction enters fourth PBS 680 through third prism face 483, passes through reflective polarizer 190, and exits fourth PBS 680 through first prism face 481 as red light 678 having the first polarization direction.

FIG. 6D shows the optical path of unpolarized blue light 690 through light combiner 600. In this embodiment, unpolarized blue light 690 enters third PBS 660 through first prism face 461 and exits fourth PBS 680 through first prism face 481 as unpolarized blue light comprising blue light 694 having the first polarization direction, and blue light 697 having the second polarization direction.

Blue light 690 enters third PBS 660 through first prism face 461 and intercepts reflective polarizer 190 where it is split into blue light 691 having the first polarization direction and blue light 692 having the second polarization direction.

Blue light 691 having the first polarization direction exits third PBS 660 through third prism face 463, and changes to blue light 693 having the second polarization direction as it passes through third CSSRP filter 633. Blue light 693 having the second polarization direction enters second PBS 640 through second prism face 442, reflects from reflective polarizer 190, exits second PBS 640 through third prism face 443, and passes unchanged through second CSSRP filter 632. Blue light 693 having the second polarization direction enters first PBS 620 through second prism face 422, reflects from reflective polarizer 190, exits first PBS 620 through third prism face 423, changes to blue light 695 having the first polarization direction as it passes through first CSSRP filter 631, and enters fourth PBS 680 through second prism face 482. Blue light 695 having the first polarization direction, passes through reflective polarizer 190, exits fourth PBS 680 through fourth prism face 484, and changes to blue circularly polarized light 699B as it passes through quarter-wave retarder 425. Blue circularly polarized light 699B changes direction of circular polarization as it reflects from mirror 430, changes to blue light 697 having the second polarization direction as it passes through quarter-wave retarder 425, enters fourth PBS 680 through fourth prism face 484, reflects from reflective polarizer 190, and exits fourth PBS 680 through first prism face 481 as blue light 697 having the second polarization direction.

Blue light 692 having the second polarization direction reflects from reflective polarizer 190, exits third PBS 660 through fourth prism face 464, changes to blue circularly polarized light 699B as it passes through quarter-wave retarder 425, changes direction of circular polarization as it reflects from mirror 430, and changes to blue light 694 having the first polarization direction as it again passes through quarter-wave retarder 425. Blue light 694 having the first polarization direction enters third PBS 660 through fourth prism face 464, passes through reflective polarizer 190, exits third PBS 660 through second prism face 462, and passes unchanged through fourth CSSRP filter 634. Blue light 694 having the first polarization direction enters fourth PBS 680 through third prism face 483, passes through reflective polarizer 190, and exits fourth PBS 680 through first prism face 481 as blue light 694 having the first polarization direction.

In a further aspect, a method of splitting light using the light combiner 600 includes changing the propagation direction of the first, second, third, and combined light, 650, 670, 690, 601, respectively, shown in FIG. 6A-6D. Combined light 601 is directed toward first prism face 481 of fourth PBS 680, and at least one of the first, second and third wavelength spectrum light is received from first prism face 421, 441, 461 of first, second and third PBS 620, 640, 660, respectively.

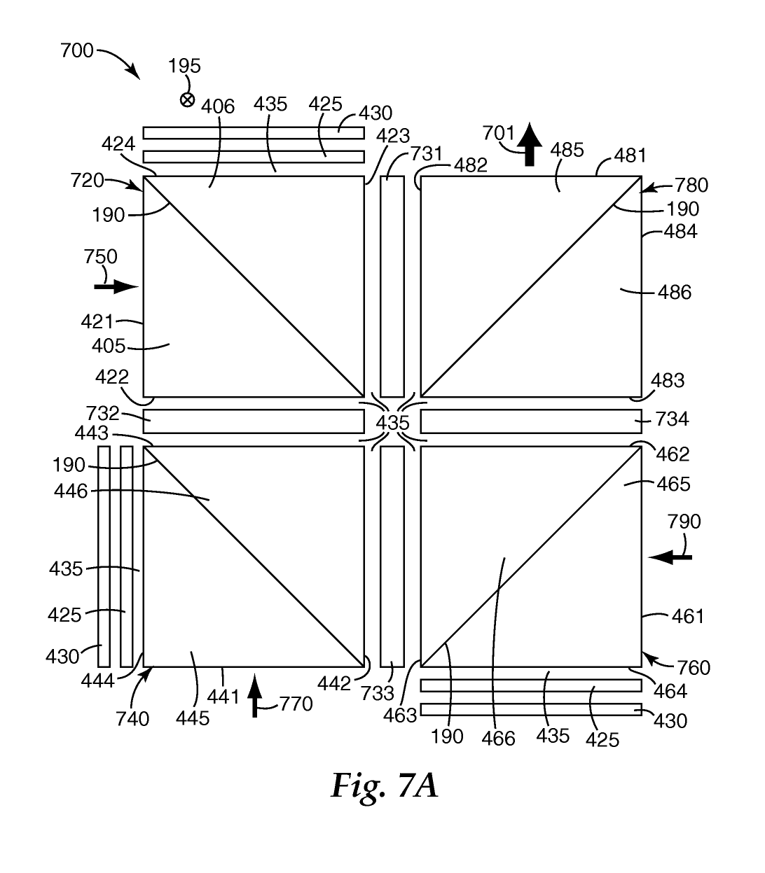

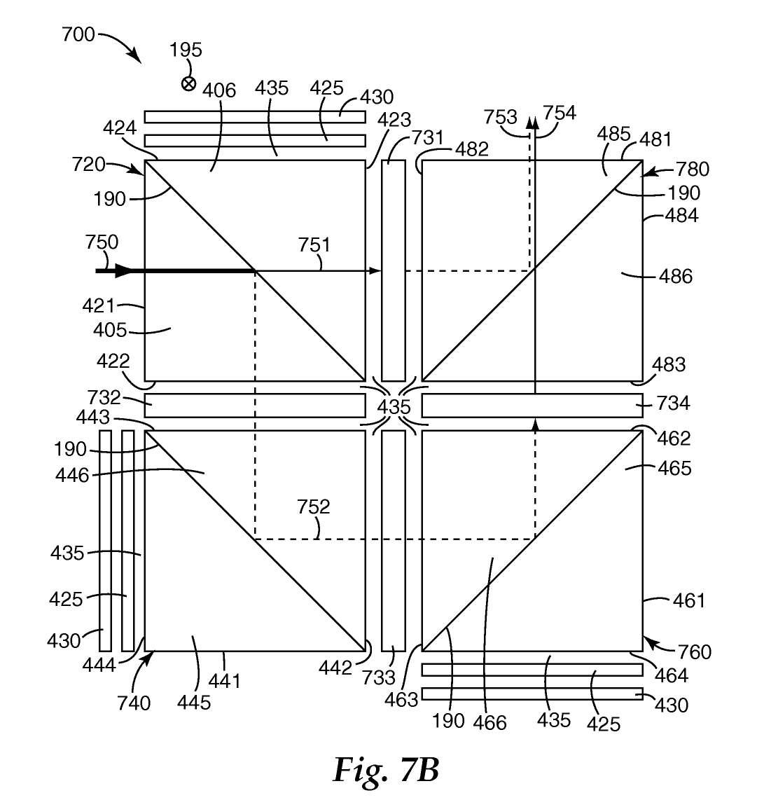

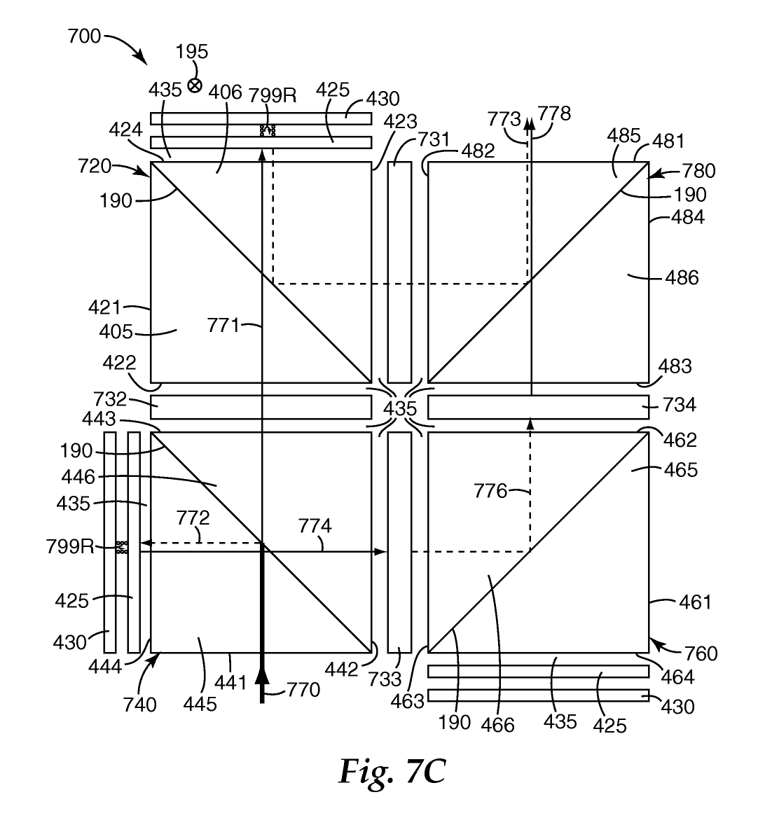

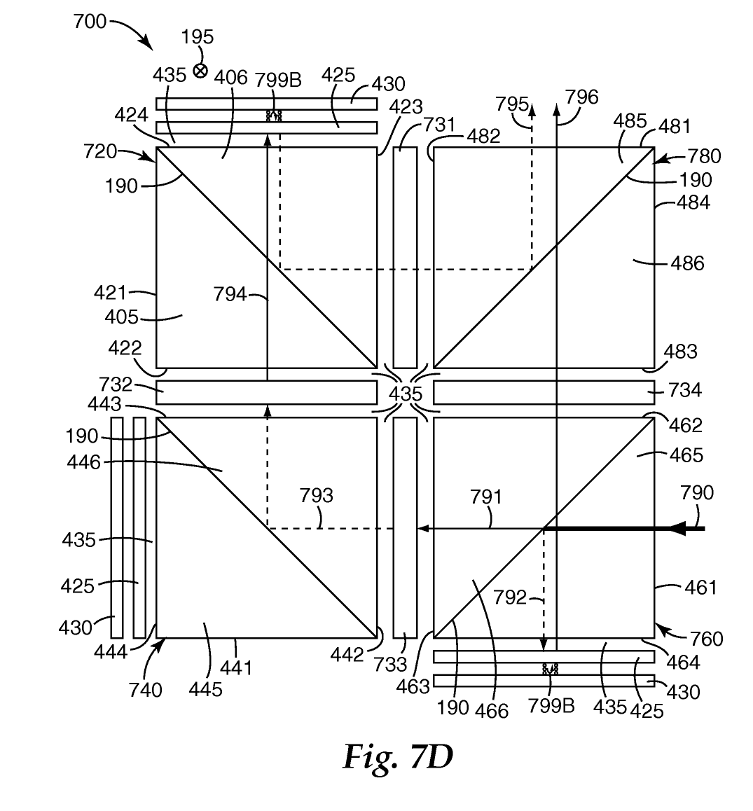

In one aspect, FIG. 7A is a top view schematic representation of a light combiner 700 that includes a first, second, third and fourth PBS 720, 740, 760, 780, respectively. A first, second, third and fourth CSSRP filter, 731, 732, 733 and 734, respectively, is disposed between each pair of adjacent PBSs (720 and 780, 720 and 740, 740 and 760, 760 and 780), respectively. Rotation of polarization in each of the CSSRP filters, 731, 732, 733 and 734, is dependent on the color of light passing through each of the filters. According to one aspect, each of the filters comprises a ColorSelect™ filter available from ColorLink Incorporated, Boulder, Colo. A polarization rotating reflector comprising retarder 425 and mirror 430 is disposed facing a fourth prism face 424, 444, 464 of each of the first, second and third PBS 720, 740, 760, respectively. In one embodiment, retarder 425 is a quarter-wave retarder orientated at 45° to a first polarization direction 195.

First PBS 720 includes a first prism 405 having a first and second prism face 421, 422 having a 90° angle between them, and a second prism 406 having a third and fourth prism face 423, 424 having a 90° angle between them. A reflective polarizer 190 is disposed between first and second prisms 405, 406 such that first prism face 421 is opposite third prism face 423. Reflective polarizer 190 can be a Cartesian reflective polarizer aligned to the first polarization direction 195 (in this view, perpendicular to the page). Reflective polarizer 190 can instead be a non-Cartesian polarizer.

Second PBS 740 includes a first prism 445 having a first and fourth prism face 441, 444 having a 90° angle between them, and a second prism 446 having a second and third prism face 442, 443 having a 90° angle between them. The reflective polarizer 190 is disposed between first and second prisms 445, 446 such that first prism face 441 is opposite third prism face 443.

Third PBS 760 includes a first prism 465 having a first and fourth prism face 461, 464 having a 90° angle between them, and a second prism 466 having a second and third prism face 462, 463 having a 90° angle between them. The reflective polarizer 190 is disposed between first and second prisms 465, 466 such that first prism face 461 is opposite third prism face 463.

Fourth PBS 780 includes a first prism 485 having a first and second prism face 481, 482 having a 90° angle between them, and a second prism 486 having a third and fourth prism face 483, 484 having a 90° angle between them. The reflective polarizer 190 is disposed between first and second prisms 485, 486 such that first prism face 481 is opposite third prism face 483.

An optically transmissive material 435 is disposed adjacent each of the prism faces. The optically transmissive material 435 can be any material that has an index of refraction lower than the index of refraction of prisms 405, 406, 445, 446, 465, 466, 485, 486. In one embodiment, the optically transmissive material 435 is air. In another embodiment, the optically transmissive material 435 is an optical adhesive which bonds the retarders 425 and the CSSRP filters 731, 732, 733, 734, to their respective prism faces.

In one aspect, a method of combining light using the light combiner 700 is shown in FIG. 7A. A first wavelength spectrum light 750 is directed toward first prism face 421 of first PBS 720, a second wavelength spectrum light 770 is directed toward first prism face 441 of second PBS 740, a third wavelength spectrum light 790 is directed toward first prism face 461 of third PBS 760, and a combined light 701 is received from first prism face 481 of fourth PBS 780. In one embodiment, at least two of the first, second or third wavelength spectrum light 750, 770, 790 is directed toward the respective prism faces 421, 441, 461, and combined light 701 is received from first prism face 461 of fourth PBS 780. In one embodiment, first, second and third wavelength spectrum light 750, 770, 790 are unpolarized light, and the combined light 701 is also unpolarized. Each of the first, second, and third lights 750, 770, 790 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

In one embodiment, first CSSRP filter 731 is selected to change the polarization direction of the first wavelength spectrum light 750, second CSSRP filter 732 is selected to change the polarization direction of the third wavelength spectrum light 790, third CSSRP filter 733 is selected to change the polarization direction of the second and third wavelength spectrums light 770 and 790, and the fourth CSSRP filter 734 is selected to change the polarization direction of the first and second wavelength spectrums light 750 and 770. In a further embodiment shown in FIGS. 7A-7D, the first, second and the third wavelength spectrum light 750, 770, 790 are green, red and blue unpolarized light, respectively, the first CSSRP filter 731 is a green/magenta CSSRP filter, the second CSSRP filter 432 is a blue/yellow CSSRP filter, the third CSSRP filter 733 is a magenta/green CSSRP filter, the fourth CSSRP filter 734 is a cyan/red CSSRP filter, and the combined light 701 is white unpolarized light.

Turning now to FIG. 7B, the optical path of unpolarized green light 750 through light combiner 700 is described. In this embodiment, unpolarized green light 750 enters first PBS 720 through first prism face 421 and exits fourth PBS 780 through first prism face 481 as unpolarized green light comprising green light 754 having the first polarization direction, and green light 753 having the second polarization direction.

Green light 750 enters first PBS 720 through first prism face 421, intercepts reflective polarizer 190, and is split into green light 751 having the first polarization direction and green light 752 having the second polarization direction.

Green light 751 having the first polarization direction exits first PBS 720 through third prism face 423, changes polarization direction as it passes through first CSSRP filter 731, and enters fourth PBS 780 through second prism face 482 as green light 753 having the second polarization direction. Green light 753 having the second polarization direction reflects from reflective polarizer 190, and exits fourth PBS 780 through first prism face 481 as green light 753 having the second polarization direction.

Green light 752 having the second polarization direction exits first PBS 720 through second prism face 422, passes through second CSSRP filter 732 without change of polarization, enters second PBS 740 through third prism face 443, reflects from reflective polarizer 190, exits second PBS 740 through second prism face 442, passes through third CSSRP filter 733 without change of polarization, enters third PBS 760 through third prism face 463, reflects from reflective polarizer 190, exits third PBS 760 through second prism face 462, and changes to green light 754 having the first polarization direction as it passes through fourth CSSRP filter 734. Green light 754 having the first polarization direction enters fourth PBS 780 through third prism face 483, passes through reflective polarizer, and exits fourth PBS 780 through first prism face 481 as green light 754 having the first polarization direction.

FIG. 7C shows the optical path of unpolarized red light 770 through light combiner 700. In this embodiment, unpolarized red light 770 enters second PBS 740 through first prism face 441 and exits fourth PBS 780 through first prism face 481 as unpolarized red light comprising red light 778 having the first polarization direction, and red light 773 having the second polarization direction.

Red light 770 enters second PBS 740 through first prism face 441, intercepts reflective polarizer 190, and is split into red light 771 having the first polarization direction and red light 772 having the second polarization direction.

Red light 771 having the first polarization direction exits second PBS 740 through third prism face 443, passes unchanged through second CSSRP filter 732, enters first PBS 720 through second prism face 422, passes through reflective polarizer 190, exits first PBS 720 through fourth prism face 424, and changes to red circularly polarized light 799R as it passes through quarter-wave retarder 425. Red circularly polarized light 799R changes the direction of circular polarization as it reflects from mirror 430, changes to red light 773 having the second polarization direction as it passes through quarter-wave retarder 425, and re-enters first PBS 720 through fourth prism face 424. Red light 773 having the second polarization direction reflects from reflective polarizer 190, exits first PBS 720 through third prism face 423, passes unchanged through first CSSRP filter 731, enters fourth PBS 780 through second prism face 482, reflects from reflective polarizer 190, and exits fourth PBS 780 through first prism face 481 as red light 773 having the second polarization direction.

Red light 772 having the second polarization direction exits second PBS 740 through fourth prism face 444, and changes to red circularly polarized light 799R as it passes through quarter-wave retarder 425. Red circularly polarized light 799R changes the direction of circular polarization as it reflects from mirror 430, changes to red light 774 having the first polarization direction as it passes through quarter-wave retarder 425, enters second PBS 740 through fourth prism face 444, passes through reflective polarizer 190, exits second PBS 740 through second prism face 442, and changes to red light 776 having the second polarization direction as it passes through third CSSRP filter 733. Red light 776 having the second polarization direction enters third PBS 760 through third prism face 463, reflects from reflective polarizer 190, exits third PBS 760 through second prism face 462, and changes to red light 778 having the first polarization direction as it passes through fourth CSSRP filter 734. Red light 778 having the first polarization direction enters fourth PBS 780 through third prism face 483, passes through reflective polarizer 190, and exits fourth PBS 780 through first prism face 481 as red light 778 having the first polarization direction.

FIG. 7D shows the optical path of unpolarized blue light 790 through light combiner 700. In this embodiment, unpolarized blue light 790 enters third PBS 760 through first prism face 461 and exits fourth PBS 780 through first prism face 481 as unpolarized blue light comprising blue light 796 having the first polarization direction, and blue light 795 having the second polarization direction.

Blue light 790 enters third PBS 760 through first prism face 461, intercepts reflective polarizer 190, and is split into blue light 791 having the first polarization direction and blue light 792 having the second polarization direction.

Blue light 791 having the first polarization direction exits third PBS 760 through third prism face 463, and changes to blue light 793 having the second polarization direction as it passes through third CSSRP filter 733, enters second PBS 740 through second prism face 442, reflects from reflective polarizer 190, exits second PBS 740 through third prism face 443, and changes to blue light 794 having the first polarization direction as it passes through second CSSRP filter 732. Blue light 794 having the first polarization direction enters first PBS 720 through second prism face 422, passes through reflective polarizer 190, exits first PBS 720 through fourth prism face 424, and changes to blue circularly polarized light 799B as it passes through quarter-wave retarder 425. Blue circularly polarized light 799B changes direction of circular polarization as it reflects from mirror 430, changes to blue light 795 having the second polarization direction as it passes through quarter-wave retarder 425, enters first PBS 720 through fourth prism face 424, reflects from reflective polarizer 190, and exits first PBS 720 through third prism face 423.

Blue light 795 having the second polarization direction passes unchanged through first CSSRP filter 731, enters fourth PBS 780 through second prism face 482, reflects from reflective polarizer 190, and exits fourth PBS 780 through first prism face 481 as blue light 795 having the second polarization direction.

Blue light 792 having the second polarization direction exits third PBS 790 through fourth prism face 464, changes to blue circularly polarized light 799B as it passes through quarter-wave retarder 425, changes direction of circular polarization as it reflects from mirror 430, and changes to blue light 796 having the first polarization direction as it passes through quarter-wave retarder 425. Blue light 796 having the first polarization direction enters third PBS 760 through fourth prism face 464, passes through reflective polarizer 190, exits third PBS 760 through second prism face 462, passes unchanged through fourth CSSRP filter 734, enters fourth PBS 780 through third prism face 483, passes through reflective polarizer 190, and exits fourth PBS 780 through first prism face 481 as blue light 796 having the first polarization direction.

In a further aspect, a method of splitting light using the light combiner 700 includes changing the propagation direction of the first, second, third, and combined light, 750, 770, 790, 701, respectively, shown in FIG. 7A-7D. Combined light 701 is directed toward first prism face 481 of fourth PBS 780, and at least one of the first, second and third wavelength spectrum light is received from first prism face 421, 441, 461 of first, second and third PBS 720, 740, 760, respectively.

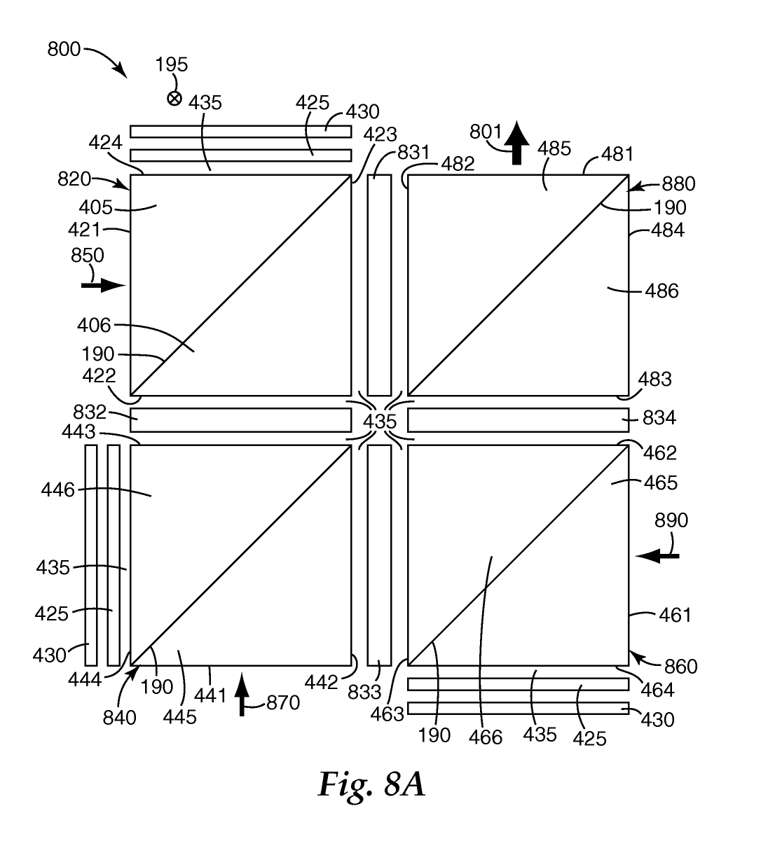

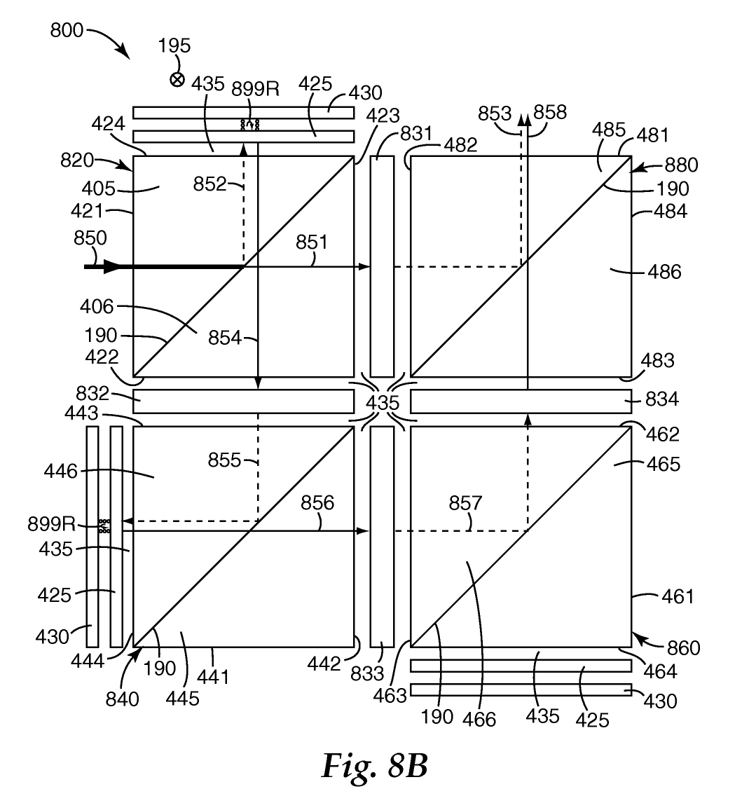

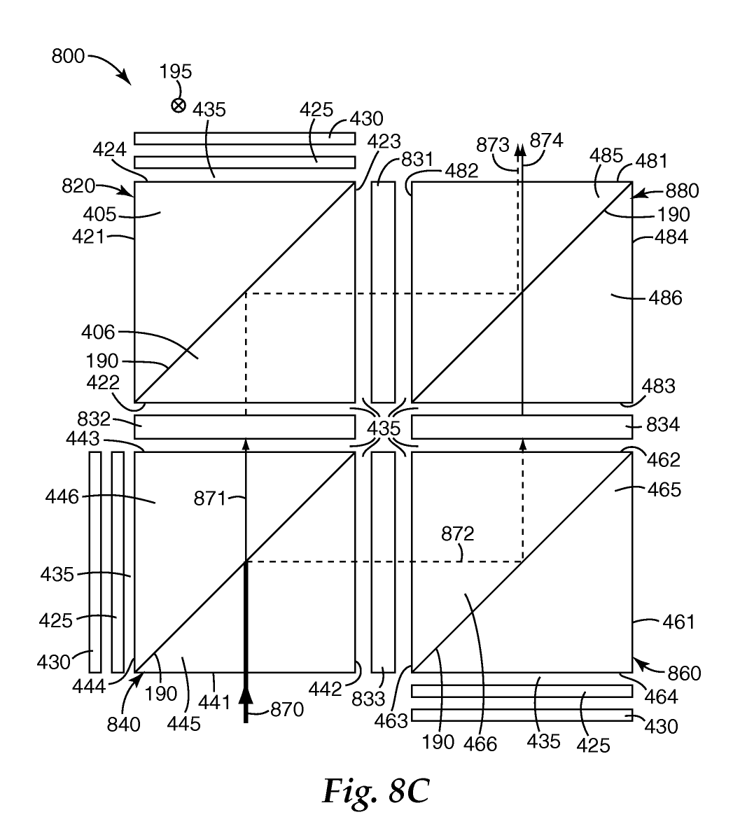

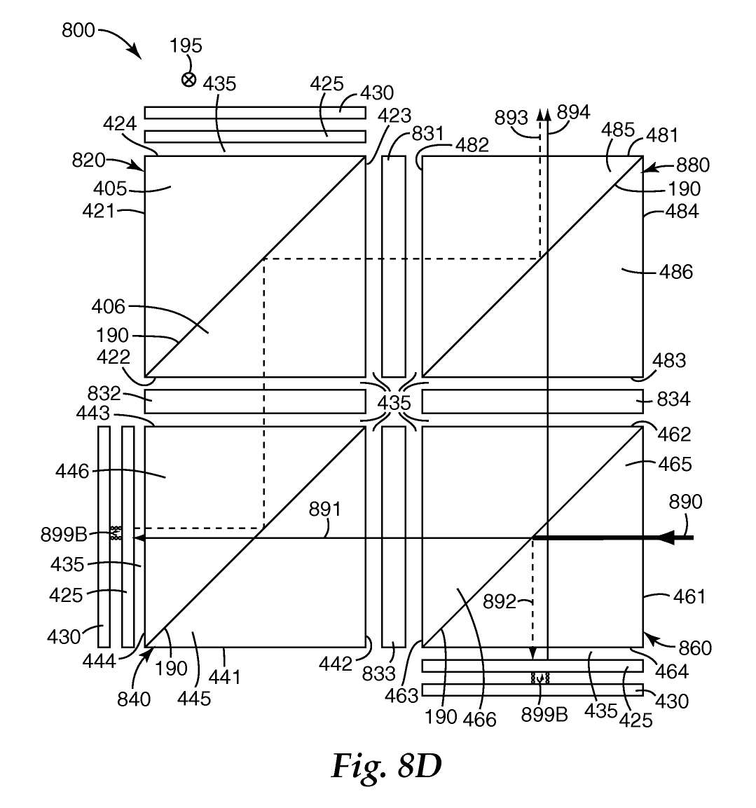

In one aspect, FIG. 8A is a top view schematic representation of a light combiner 800 that includes a first, second, third and fourth PBS 820, 840, 860, 880, respectively. A first, second, third and fourth CSSRP filter, 831, 832, 833 and 834, respectively, is disposed between each pair of adjacent PBSs (820 and 880, 820 and 840, 840 and 860, 860 and 880), respectively. Rotation of polarization in each of the CSSRP filters, 831, 832, 833 and 834, is dependent on the color of light passing through each of the filters. According to one aspect, each of the filters comprises a ColorSelect™ filter available from ColorLink Incorporated, Boulder, Colo. A polarization rotating reflector comprising retarder 425 and mirror 430 is disposed facing a fourth prism face 424, 444, 464 of each of the first, second and third PBS 820, 840, 860, respectively. In one embodiment, retarder 425 is a quarter-wave retarder orientated at 45° to a first polarization direction 195.

First PBS 820 includes a first prism 405 having a first and fourth prism face 421, 424 having a 90° angle between them, and a second prism 406 having a second and third prism face 422, 423 having a 90° angle between them. A reflective polarizer 190 is disposed between first and second prisms 405, 406 such that first prism face 421 is opposite third prism face 423. Reflective polarizer 190 can be a Cartesian reflective polarizer aligned to the first polarization direction 195 (in this view, perpendicular to the page). Reflective polarizer 190 can instead be a non-Cartesian polarizer.

Second PBS 840 includes a first prism 445 having a first and second prism face 441, 442 having a 90° angle between them, and a second prism 446 having a third and fourth prism face 443, 444 having a 90° angle between them. The reflective polarizer 190 is disposed between first and second prisms 445, 446 such that first prism face 441 is opposite third prism face 443.

Third PBS 860 includes a first prism 465 having a first and fourth prism face 461, 464 having a 90° angle between them, and a second prism 466 having a second and third prism face 462, 463 having a 90° angle between them. The reflective polarizer 190 is disposed between first and second prisms 465, 466 such that first prism face 461 is opposite third prism face 463.

Fourth PBS 880 includes a first prism 485 having a first and second prism face 481, 482 having a 90° angle between them, and a second prism 486 having a third and fourth prism face 483, 484 having a 90° angle between them. The reflective polarizer 190 is disposed between first and second prisms 485, 486 such that first prism face 481 is opposite third prism face 483.

An optically transmissive material 435 is disposed adjacent each of the prism faces. The optically transmissive material 435 can be any material that has an index of refraction lower than the index of refraction of prisms 405, 406, 445, 446, 465, 466, 485, 486. In one embodiment, the optically transmissive material 435 is air. In another embodiment, the optically transmissive material 435 is an optical adhesive which bonds the retarders 425 and the CSSRP filters 831, 832, 833, 834, to their respective prism faces.

In one aspect, a method of combining light using the light combiner 800 is shown in FIG. 8A. A first wavelength spectrum light 850 is directed toward first prism face 421 of first PBS 820, a second wavelength spectrum light 870 is directed toward first prism face 441 of second PBS 840, a third wavelength spectrum light 890 is directed toward first prism face 461 of third PBS 860, and a combined light 801 is received from first prism face 481 of fourth PBS 880. In one embodiment, at least two of the first, second or third wavelength spectrum light 850, 870, 890 is directed toward the respective prism faces 421, 441, 461, and combined light 801 is received from first prism face 461 of fourth PBS 880. In one embodiment, first, second and third wavelength spectrum light 850, 870, 890 are unpolarized light, and the combined light 801 is also unpolarized. Each of the first, second, and third lights 850, 870, 890 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

In one embodiment, first and third CSSRP filters 831, 833 are selected to change the polarization direction of the first wavelength spectrum light 850, and the second and fourth CSSRP filters 832, 834 are selected to change the polarization direction of the first and second wavelength spectrums light 850 and 870. In a further embodiment shown in FIGS. 8A-8D, the first, a second and the third wavelength spectrum light 850, 870, 890 are red, green and blue unpolarized light, respectively, the first and third CSSRP filters 831, 833 are red/cyan CSSRP filters, the second and fourth CSSRP filters 832, 834 are yellow/blue CSSRP filters, and the combined light 801 is white unpolarized light.

Turning now to FIG. 8B, the optical path of unpolarized red light 850 through light combiner 800 is described. In this embodiment, unpolarized red light 850 enters first PBS 820 through first prism face 421 and exits fourth PBS 880 through first prism face 481 as unpolarized red light comprising red light 858 having the first polarization direction, and red light 853 having the second polarization direction.

Red light 850 enters first PBS 820 through first prism face 421, intercepts reflective polarizer 190, and is split into red light 851 having the first polarization direction and red light 852 having the second polarization direction.

Red light 851 having the first polarization direction exits first PBS 820 through third prism face 423, changes polarization direction as it passes through first CSSRP filter 831, and enters fourth PBS 880 through second prism face 482 as red light 853 having the second polarization direction. Red light 853 having the second polarization direction reflects from reflective polarizer 190, and exits fourth PBS 880 through first prism face 481 as red light 853 having the second polarization direction.

Red light 852 having the second polarization direction exits first PBS 820 through fourth prism face 424, and changes to red circularly polarized light 899R as it passes through quarter-wave retarder 425. Red circularly polarized light 899R reflects from mirror 430, changes direction of circular polarization, and changes to red light 854 having the first polarization direction as it passes through quarter-wave retarder 425. Red light 854 having the first polarization direction enters first PBS 820 through fourth prism face 424, passes through reflective polarizer 190, exits first PBS 820 through second prism face 422, and changes polarization direction as it passes through first CSSRP filter 831, to become red light 855 having the second polarization direction. Red light 855 having the second polarization direction enters second PBS 840 through third prism face 443, reflects from reflective polarizer 190, exits second PBS 840 through fourth prism face 444, changes to red circularly polarized light 899R as it passes through quarter-wave retarder 425, changes direction of circular polarization as it reflects from mirror 430, and becomes red light 856 having the first polarization direction as it again passes through quarter-wave retarder 425. Red light 856 having the first polarization direction enters second PBS 840 through fourth prism face 444, passes through reflective polarizer 190, exits second PBS 840 through second prism face 442, changes to red light 857 having the second polarization direction as it passes through third CSSRP filter 433. Red light 857 having the second polarization direction enters third PBS 860 through third prism face 463, reflects from reflective polarizer 190, exits third PBS 860 through second prism face 462, and changes to red light 858 having the first polarization direction as it passes through fourth CSSRP filter 434. Red light 858 having the first polarization direction enters fourth PBS 880 through third prism face 483, passes through reflective polarizer 190, and exits fourth PBS 880 through first prism face 481 as red light 858 having the first polarization direction.

FIG. 8C shows the optical path of unpolarized green light 870 through light combiner 800. In this embodiment, unpolarized green light 870 enters second PBS 840 through first prism face 441 and exits fourth PBS 880 through first prism face 481 as unpolarized green light comprising green light 874 having the first polarization direction, and green light 873 having the second polarization direction.

Green light 870 enters second PBS 840 through first prism face 441, intercepts reflective polarizer 190, and is split into green light 871 having the first polarization direction and green light 872 having the second polarization direction.

Green light 871 having the first polarization direction exits second PBS 840 through third prism face 443, and changes to green light 873 as it passes through second CSSRP filter 832. Green light 873 having the second polarization direction enters first PBS 820 through second prism face 422, reflects from reflective polarizer 190, exits first PBS 820 through third prism face 423, passes unchanged through first CSSRP filter 831, enters fourth PBS 880 through second prism face 482, reflects from reflective polarizer 190 and exits fourth PBS 880 through first prism face 481 as green light 873 having the second polarization direction.

Green light 872 having the second polarization direction exits second PBS 840 through second prism face 442, passes through third CSSRP filter 433 without change of polarization, enters third PBS 860 through third prism face 463, reflects from reflective polarizer 190, exits third PBS 860 through second prism face 462, and changes to green light 874 having the first polarization direction as it passes through fourth CSSRP filter 834. Green light 874 having the first polarization direction enters fourth PBS 880 through third prism face 483, passes through reflective polarizer 190, and exits fourth PBS 880 through first prism face 461 as green light 874 having the first polarization direction.

FIG. 8D shows the optical path of unpolarized blue light 890 through light combiner 800. In this embodiment, unpolarized blue light 890 enters third PBS 860 through first prism face 461 and exits fourth PBS 880 through first prism face 481 as unpolarized blue light comprising blue light 894 having the first polarization direction, and blue light 893 having the second polarization direction.

Blue light 890 enters third PBS 860 through first prism face 441, intercepts reflective polarizer 190, and is split into blue light 891 having the first polarization direction and blue light 892 having the second polarization direction.

Blue light 891 having the first polarization direction exits third PBS 860 through third prism face 463, passes unchanged through third CSSRP filter 833, enters second PBS 840 through second prism face 442, passes through reflective polarizer 190, exits second PBS 840 through fourth prism face 444, and changes to blue circularly polarized light 899B as it passes through quarter-wave retarder 425. Blue circularly polarized light 899B changes the direction of circular polarization as it reflects from mirror 430, changes to blue light 893 having the second polarization direction as it passes through quarter-wave retarder 425, and re-enters second PBS 840 through fourth prism face 444. Blue light 893 having the second polarization direction reflects from reflective polarizer 190, exits second PBS 840 through third prism face 443, passes unchanged through second CSSRP filter 832, and enters first PBS 820 through second prism face 422. Blue light 893 having the second polarization direction reflects from reflective polarizer 190, exits first PBS 820 through third prism face 483, passes unchanged through first CSSRP filter 831, enters fourth PBS 880 through second prism face 482, reflects from reflective polarizer 190, and exits fourth PBS 880 through first prism face 481 as blue light 893 having the second polarization direction.

Blue light 892 having the second polarization direction exits third PBS 860 through fourth prism face 464, changes to blue circularly polarized light 899B as it passes through quarter-wave retarder 425, changes the direction of circular polarization as it reflects from mirror 430, and changes to blue light 894 having the first polarization direction as it passes through quarter-wave retarder 425. Blue light 894 having the first polarization direction enters third PBS 860 through fourth prism face 464, passes through reflective polarizer 190, exits third PBS 860 through second prism face 462, passes unchanged through fourth CSSRP filter 834, enters fourth PBS 880 through third prism face 483, passes through reflective polarizer 190 and exits fourth PBS 880 through first prism face 481 as blue light 894 having the first polarization direction.

In a further aspect, a method of splitting light using the light combiner 800 includes changing the propagation direction of the first, second, third, and combined light, 850, 870, 890, 801, respectively, shown in FIG. 8A-8D. Combined light 801 is directed toward first prism face 481 of fourth PBS 880, and at least one of the first, second and third wavelength spectrum light is received from first prism face 421, 441, 461 of first, second and third PBS 820, 840, 860, respectively.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A light combiner, comprising:
four polarizing beam splitters, each polarizing beam splitter comprising:
first and second prisms;
first, second, third and fourth prism faces, wherein the first prism face is opposite the third prism face;
a reflective polarizer disposed between the first and second prisms;
a first of the four polarizing beam splitters positioned adjacent a second and a fourth polarizing beam splitter, the second prism face of each polarizing beam splitter disposed facing the third prism face of an adjacent polarizing beam splitter, and the second prism face of the first polarizing beam splitter facing the third prism face of the second polarizing beam splitter;
first, second, third and fourth filters, each filter changing a polarization direction of at least one selected wavelength spectrum of light without changing a polarization direction of at least another selected wavelength spectrum of light, each filter disposed between a different adjacent pair of the four polarizing beam splitters; and
a reflector that reflects and changes the polarization direction of incident light, disposed facing the fourth prism face of each of the first, second and third polarizing beam splitters.

2. The light combiner of claim 1, wherein at least two filters of the first, second, third and fourth filters change the polarization direction in different selected wavelength spectrums.

3. The light combiner of claim 1, wherein the first filter is disposed between the first and fourth polarizing beam splitters, the second filter is disposed between the first and second polarizing beam splitters, the third filter is disposed between the second and third polarizing beam splitters, and the fourth filter is disposed between the third and fourth polarizing beam splitters.

4. The light combiner of claim 1, wherein the at least one selected wavelength spectrum and the at least another selected wavelength spectrum are both in the visible wavelength spectrum.

5. The light combiner of claim 1, wherein the reflective polarizer is aligned to a first polarization direction.

6. The light combiner of claim 5, wherein the reflective polarizer is a Cartesian reflective polarizer.

7. The light combiner of claim 6, wherein the Cartesian reflective polarizer is a polymeric multilayer optical film.

8. The light combiner of claim 5, wherein each reflector comprises a mirror and a quarter-wave retarder aligned at 45° to the first polarization direction.

9. The light combiner of claim 1, wherein each polarizing beam splitter further comprises end faces, and wherein all of the prism faces and end faces are polished.

10. The light combiner of claim 9, further comprising an optically transmissive material in contact with each of the polished faces, the index of refraction of each of the first and second prisms being greater than the index of refraction of the optically transmissive material so that total internal reflection can occur within the first and second prisms.

11. The light combiner of claim 10, wherein the optically transmissive material in contact with at least one of the polished faces is air.

12. The light combiner of claim 10, wherein the optically transmissive material in contact with at least one of the polished faces is an optical adhesive.

13. The light combiner of claim 3, wherein the first prism includes the first and second prism faces, the second prism includes the third and fourth prism faces, the first and third filters change the polarization direction of a first wavelength spectrum light without changing another wavelength spectrum of light, and the second and fourth filters change the polarization direction of a third wavelength spectrum light without changing another wavelength spectrum of light.

14. The light combiner of claim 13, wherein the first, a second and the third wavelength spectrums are red, green and blue respectively, the first and third filters comprise red/cyan color-selective stacked retardation polarization filters, and the second and fourth filters comprise blue/yellow color-selective stacked retardation polarization filters.

15. The light combiner of claim 13, wherein the first, a second and the third wavelength spectrums are green, red and blue respectively, the first and third filters comprise green color-selective stacked retardation polarization filters, and the second and fourth filters comprise blue color-selective stacked retardation polarization filters.

16. The light combiner of claim 3, wherein
the first prism of each of the second and fourth polarizing beam splitters includes the first and second prism faces;
the first prism of each of the first and third polarizing beam splitters includes the first and fourth prism faces;
the first and third filters change the polarization direction of a first wavelength spectrum light without changing another wavelength spectrum of light, and the second and fourth filters change the polarization direction of the first and a second wavelength spectrum light without changing another wavelength spectrum of light.

17. The light combiner of claim 16, wherein the first, the second and a third wavelength spectrums are red, green and blue respectively, the first and third filters comprise red/cyan color-selective stacked retardation polarization filters, and the second and fourth filters comprise blue/yellow color-selective stacked retardation polarization filters.

18. The light combiner of claim 3, further comprising an additional reflector disposed facing the fourth prism face of the fourth polarizing beam splitter, wherein the first prism includes the first and fourth prism faces, the second prism includes the second and third prism faces, the first and third filters change the polarization direction of a second and a third wavelength spectrum light without changing another wavelength spectrum of light, and the second and fourth filters change the polarization direction of a first and the second wavelength spectrum light without changing another wavelength spectrum of light.

19. The light combiner of claim 18, wherein the first, second and third wavelength spectrums are green, red and blue respectively, the first and third filters comprise green/magenta color-selective stacked retardation polarization filters, and the second and fourth filters comprise yellow/blue color-selective stacked retardation polarization filters.

20. The light combiner of claim 3, wherein
the first prism of each of the first and fourth polarizing beam splitters includes the first and second prism faces;
the first prism of each of the second and third polarizing beam splitters includes the first and fourth prism faces;
the first filter changes the polarization direction of a first wavelength spectrum light without changing another wavelength spectrum of light;
the second filter changes the polarization direction of a third wavelength spectrum light without changing another wavelength spectrum of light;
the third filter changes the polarization direction of a second and third wavelength spectrum light without changing another wavelength spectrum of light; and
the fourth filter changes the polarization direction of the first and second wavelength spectrum light without changing another wavelength spectrum of light.

21. The light combiner of claim 20, wherein the first, second and third wavelength spectrums are green, red and blue respectively, the first filter comprises a green/magenta color-selective stacked retardation polarization filter, the second filter comprises a blue/yellow color-selective stacked retardation polarization filter, the third filter comprises a magenta/green color-selective stacked retardation polarization filter, and the fourth filter comprises a cyan/red color-selective stacked retardation polarization filter.

22. A method of combining light, comprising:
providing the light combiner of claim 14, 15, 17, 18 or 21;
directing light of at least two of the first, second, and third wavelength spectrums toward the first prism face of the first, second, and third polarizing beam splitters, respectively; and
receiving combined light from the first prism face of the fourth polarizing beam splitter.

23-29. (canceled)
